(19) United States
(12) Patent Application Publication
(10) Pub. No.: US 2008/0286677 A1
(43) Pub. Date: Nov. 20, 2008

(54) Toner for developer

(75) Inventors: Naruo Yabe, Osaka-shi (JP); Takanori Tanaka, Osaka-shi (JP); Akira Tanaka, Osaka-shi (JP); Kousuke Satou, Osaka-shi (JP); Yukinori Nakayama, Osaka-shi (JP)

Correspondence Address: CASELLA & HESPOS, 274 MADISON AVENUE, NEW YORK, NY, 10016, US

(73) Assignee: KYOCERA MITA CORPORATION, Osaka-shi (JP)

(21) Appl. No.: 11/998,781

(22) Filed: Nov. 30, 2007

(30) Foreign Application Priority Data
Nov. 30, 2006 (JP) 2006-324343
Nov. 30, 2006 (JP) 2006-324344
Dec. 12, 2006 (JP) 2006-334628
Dec. 12, 2006 (JP) 2006-334629
Dec. 26, 2006 (JP) 2006-350231
Dec. 26, 2006 (JP) 2006-350232
May 30, 2007 (JP) 2007-143756

(51) Int. Cl. G03G 9/087

(52) U.S. Cl. 430/108.7; 430/110.3

(57) ABSTRACT

Disclosed is a toner for a developer comprising cylindrical toner particles formed of a toner composition containing at least a binder resin and a releasant as toner components, and an external additive, wherein the cylindrical toner particles have an average circularity of 0.880 or more and 0.930 or less.

### BACKGROUND OF THE INVENTION

1. Field of the Invention

The present invention relates to a toner for a developer, containing toner particles and an external additive, and particularly to a toner for a developer, containing improved toner particles.

2. Description of the Related Art

In image forming apparatuses such as a laser printer, an electrostatic copying machine, a plain paper facsimile apparatus and a composite machine thereof, a series of image forming steps are started by uniformly charging the surface of an image supporting material using charging means, followed by exposing using exposure means to form an electrostatic latent image, developing the electrostatic latent image using developing means to form a toner image, transferring the toner image onto the surface of a material to be printed such as paper using transfer means, and completed by fixing the image on the surface of the material to be printed.

As a developing method for developing an electrostatic latent image to form a toner image in the developing means, for example, there are known a non-magnetic one-component developing method using a non-magnetic one-component toner prepared by externally adding an external additive (e.g. silica, titanium oxide, etc.) for adjusting fluidity and the charge amount of toner particles to non-magnetic toner particles composed mainly of a binder resin, a colorant and a wax, which do not contain a magnetic component such as a magnetic powder; a two-component developing method using a two-component developer formed by mixing with a magnetic carrier in a state where the external additive is added to the non-magnetic toner particles; and a magnetic one-component developing method using a magnetic one-component toner containing, as a main component, magnetic toner particles containing a magnetic powder.

As the non-magnetic one-component developing method, for example, there are known a so-called contact type non-magnetic one-component developing method in which the non-magnetic one-component toner is supported on a developer supporting material while frictionally charging using a regulating blade in the developing means to form a lot of thin layers made of a non-magnetic one-component toner on the surface of the developer supporting material, and then the non-magnetic one-component toner in the thin layers is selectively migrated to the image supporting material by bringing the thin layers directly into contact with the electrostatic latent image on the image supporting material in a state where a developing bias is applied to the thin layers, thereby developing the electrostatic latent image to form a toner image; and a non-contact type non-magnetic one-component developing method in which a developing bias is applied in a state where the thin layers and the image supporting material face each other while maintaining a fixed distance, thereby allowing the non-magnetic one-component toner in the thin layers to selectively fly to the image supporting material and developing the electrostatic latent image to form a toner image.

Of these methods, in the latter non-contact type non-magnetic one-component developing method, since the image is formed in a non-contact state except that a friction force is applied to the non-magnetic one-component toner from the regulating blade, there is an advantage that the mechanical stress on the non-magnetic one-component toner can decrease. However, as described above, due to a mechanism of development in which the electrostatic latent image on the electrostatic latent image is developed to form a toner image by allowing the non-magnetic one-component toner to fly to the image supporting material which faces the thin layers while maintaining a fixed distance, there is a problem that the image density of the formed image decreases as compared with the contact type non-magnetic one-component developing method allowing migration of the toner in the state of being directly contacted.

Thus, in order to improve image density, for example, Japanese Unexamined Patent Publication No. 06-118693 proposes to support antimony tin oxide on toner particles of a non-magnetic one-component toner in a free state. However, since the antimony tin oxide has a low resistance value, when an image is formed under high temperature and high humidity conditions, there may be a problem of easily causing image defects such as fog in which the charge amount of the toner excessively decreases and thus toner particles are deposited on a margin portion of the formed image.

Also, Japanese Unexamined Patent Publication No. 09-043895 discloses that, as external additives to be externally added to toner particles, a first external additive capable of charging to the same polarity as that of the toner particles and a second external additive capable of charging to the polarity reversed to that of the toner particles are concomitantly used, and that AC voltage is applied to a developing bias, which is usually used in DC, in a superposed state. It is considered that, according to the above method, image density of the formed image can be improved by increasing the amount of the non-magnetic one-component toner, which is allowed to fly from the thin layers, upon development. Also, it is preferable to make the particle size of the external additive smaller. The reason is considered as follows. Namely, as the particle size of the external additive decreases, fluidity of the non-magnetic one-component toner can be improved and the thin layers of the non-magnetic one-component toner formed on the surface of the developer supporting material can be made uniform, and thus image quality of the formed image can be improved.

Also, the two-component developing method using the two-component developer is in most widespread use because friction charging of a toner for the two-component developer can be performed stably and uniformly by mixing it with a carrier.

In the two-component developing method using the two-component developer, the toner for the two-component developer is friction-charged by mixing the toner for the two-component developer with the carrier constituting the two-component developer in the developing means. Then, in the state of being friction-charged, by bringing into contact with a magnetic roll including a magnet incorporated therein, which is disposed in a state of facing the image supporting material, there is formed a so-called magnetic brush in which the carrier is formed in series in the form of spikes on the magnetic roll and the toner for the two-component developer is electrostatically deposited on the surface thereof. Furthermore, the magnetic brush is directly brought into contact with the electrostatic latent image on the image supporting material, thereby selectively migrating the toner for the two-component developer to the image supporting material, and thus the electrostatic latent image is developed to form a toner image. When the toner for the two-component developer in the two-component developer decreases as a result of consumption due to formation of the image, the replenishing toner for the two-component developer is charged in the developing means and is mixed with the carrier in the developing means, thereby being friction-charged, and thus the toner for the two-component developer is used for formation of the image, similarly.

In this two-component developing method, for example, the magnetic two-component developer is supplied to a roller-shaped developer supporting material disposed in a state of facing a drum-shaped image supporting material. For example, the developer supporting material includes a number of magnets having a magnetic pole installed therein, and therefore, the magnetic two-component developer in the form of the magnetic brush adheres onto the peripheral surface of the developer supporting material. In this developer supporting material, a developer thickness regulating plate for regulating the thickness of the developer and charging the toner is disposed while maintaining a fixed space from the surface of the developing roller, and the toner is charged by friction between the toner and the magnetic carrier when the developer passes through the developer thickness regulating plate. When the magnetic two-component developer in the form of the magnetic brush is brought into contact with a photoconductor, only the toner in the magnetic two-component developer adheres onto the photoconductor to form a toner image on the photoconductor. The toner left on the photoconductor after transfer of the toner image is removed by a cleaning device.

It has recently been required particularly in the two-component developing method that the formed image is excellent in tone. For example, Japanese Unexamined Patent Publication No. 2005-164875 proposes a method of improving tone of the formed image by adjusting a size of a photoconductor drum and a developing sleeve.

However, it is desired to improve tone and developability only by improving the magnetic two-component developer, particularly the toner used in the magnetic two-component developer, without adjusting the process.

Also, as a novel image forming method using a two-component developer, for example, a hybrid developing method with a constitution of a combination of the non-contact type non-magnetic one-component developing method and the two-component developing method is known (see Japanese Unexamined Patent Publication No. 3-113474). The hybrid developing method employs developing means in which a developer supporting material is disposed in a state of facing an image supporting material and also a magnetic roll including magnets installed therein is disposed in a state of facing the developer supporting material.

In the developing means, a toner for a two-component developer is friction-charged by mixing a carrier constituting a two-component developer with the toner for a two-component developer in the developing means, and then, in this state, a magnetic brush is formed on a magnetic roll by bringing the mixture into contact with the magnetic roll. This magnetic brush is directly brought into contact with a developer supporting material, thereby migrating only the toner for a two-component developer to the developer supporting material to form thin layers of the toner for a two-component developer on the surface of the developer supporting material. Then, in a state where the thin layers and the surface of the image supporting material face each other while maintaining a fixed distance, a developing bias is applied therebetween and the toner for a two-component developer in the thin layers is selectively allowed to fly, and thus the electrostatic latent image is developed to form a toner image.

According to the hybrid developing method, while a conventional non-contact type non-magnetic one-component developing method has a problem that the image density of the formed image decreases as compared with the contact type developing method such as a two-component developing method due to the development mechanism descried previously, there is an advantage that friction charging can be performed stably and uniformly by mixing the toner for a two-component developer with the carrier similarly to the two-component developing method, and thus the image density of the formed image can be improved. Also, the hybrid developing method has an advantage that migration of the toner image to the electrostatic latent image is performed in a non-contact state, and thus a clear image can be formed without causing severe disturbance as compared with a contact type developing method such as a two-component developing method.

In the two-component developing method and the hybrid developing method, it is preferable to reduce the particle size of an external additive which is externally added to toner particles to form a toner for a two-component developer. Namely, as the particle size of the external additive decreases, fluidity of the toner for a two-component developer can be more improved. Therefore, it is considered that, in the hybrid developing method, image quality of the formed image can be improved by achieving uniformity of the thin layers of the toner for a two-component developer to be formed on the surface of the developer supporting material.

As toner particles constituting an electrophotographic toner used in various developing methods described above, those produced by a so-called grinding method have hitherto been used. According to the grinding method, toner particles are produced by melting a binder resin which constitutes toner particles and functions as a binder for fixing the toner particles onto the surface of a material to be printed such as paper, a colorant for coloring the toner particles, a wax capable of functioning as an anti-offset agent for preventing occurrence of so-called offset defects in which the toner particles adhere onto the surface of a fixing roll when the toner particles are fixed onto the surface of a material to be printed through pressing with heating by passing through a couple of fixing rolls as fixing means, and optionally a magnetic powder in case of magnetic toner particles, by mixing under heating to obtain a toner component, by solidifying the toner component under cooling, followed by grinding and optionally by classifying.

It is known that surface state of the toner particles produced by the grinding method largely varies depending on dispersion state of the respective components constituting the toner component, and the dispersion diameter of the wax exerts a large influence on the surface state of the toner particles. Namely, when the wax is not sufficiently dispersed in the toner component and the dispersion diameter is large, the toner component is broken at the portion of the wax in the grinding step and is exposed over a wide area on the surface of the toner particles prepared. When the electrophotographic toner is repeatedly used for formation of an image for a long period, the wax exposed on the surface of the toner particles is migrated to the surface of various members to be contacted with the toner particles and contaminate the members, thereby causing various problems.

For example, in the case where an electrophotographic toner is mixed with a carrier and the resulting mixture is used as a two-component developer in a two-component developing method or a hybrid developing method, when there arises so-called carrier contamination in which the wax adheres onto the surface of the carrier, friction charging due to mixing of the electrophotographic toner with the carrier is prevented and thus a large amount of the insufficiently charged electrophotographic toner is generated. This causes a decrease in image density of the formed image, so-called fog in which the electrophotographic toner adheres onto a margin portion of the formed image, and also so-called toner scattering in which the inside of an image forming apparatus is contaminated with the insufficiently charged electrophotographic toner. Also, when the wax adheres onto the surface of the image supporting material, there may arise so-called defects due to adhesion on the drum in which image defects such as black points are formed in the formed image.

To cope with these problems, for example, Japanese Unexamined Patent Publication No. 11-174730 proposes a method for regulating a dispersion diameter of a wax in toner particles produced by a grinding method within a predetermined range or less. However, in order to produce the toner particles in which the dispersion particle size of a wax is regulated within a predetermined range by carrying out the method, the kinds of binder resins and waxes usable are limited. In particular, since a wax having comparatively high melting and softening temperatures must be used, there arises a problem, as a result of the temperature capable of fixing toner particles shifting to a higher temperature, that it is impossible to obtain good fixing properties at low temperature, namely, characteristics capable of satisfactorily fixing on the surface of a material to be printed such as paper at a lower temperature by decreasing the fixing temperature of toner particles.

Japanese Unexamined Patent Publication No. 6-138704 proposes, as a novel method for producing toner particles to replace a conventional grinding method, a method for producing toner particles comprising the steps of melting toner components such as a binder resin, a colorant and a wax under heating and kneading the molten mixture (kneading step), drawing the toner components in a molten state into a cylindrical fiber (drawing step) and cutting the cylindrical fiber (cutting step). In the toner particles obtained by the above method (hereinafter referred to as a “melt blown method”), since the fracture surface of the toner components is exposed only on the cutting surface of the cylindrical fiber and other surfaces form smooth cylindrical surfaces coated with the binder resin, it is possible to decrease the area of the wax exposed to the surface of toner particles as compared with the toner particles produced by the grinding method. Therefore, it is expected that various problems described above involved in exposure of the wax may be solved.

Also, the grinding method is a method for producing a toner comprising adding a colorant, a charge control agent and a releasant to a thermoplastic resin and kneading the mixture, followed by grinding and further classification. In the grinding method for obtaining toner particles by grinding, since the toner surface forms the fracture surface, when the toner obtained by the grinding method is used, a contact area with an image supporting material (a photoconductor drum or an intermediate transfer belt) is large and thus physical adhesion (van der Waals force) is increased. Also, a charge amount may become comparatively non-uniform because of broad particle size distribution.

It is necessary to apply a comparatively large amount of an applied voltage so as to transfer such toner from the image supporting material. However, when a large voltage is applied, the charge amount of the residual toner left after transfer may become an overcharged state. When the charge amount of the residual toner left after transfer becomes the overcharged state, an electrostatic adhesion force with the image supporting material increases and thus, faulty cleaning may arise in the subsequent cleaning process by a cleaning fur brush.

In order to reduce faulty cleaning by the cleaning fur brush, for example, Japanese Unexamined Patent Publication No. 2002-229344 proposes a technique of applying separate applied voltages using two fur brushes, and Japanese Unexamined Patent Publication No. 2003-177584 proposes a technique of preliminarily charging a toner before a cleaning process by a cleaning fur brush.

It is highly required to reduce faulty cleaning in a downsized image forming apparatus which includes a transfer roller having a small size and requires application of a high voltage for transfer. However, according to the above prior art, the image forming apparatus is upsized and complicated. Therefore, reduction in faulty cleaning is preferably to be realized by improving the toner, not the size of the image forming apparatus.

Also, in a tandem type image forming apparatus, a toner image is transferred using an endless intermediate transfer belt. This image forming apparatus is provided with multiple image supporting materials, each being capable of forming a toner image with a different color. A full color image is formed on a transfer material by transferring each toner image with each color formed on each image supporting material on the intermediate transfer belt and laying each toner image with each color on the intermediate transfer belt (primary transfer) and transferring each toner image layered on the intermediate transfer belt to the transfer material (secondary transfer).

When an OHP sheet or a thin transfer material is used, there arises a problem of a so-called void phenomenon in which only a portion (particularly corresponding to the center of a character) of the toner image is not satisfactorily transferred upon secondary transfer.

It is considered that this void phenomenon is caused because stress is concentrated at a portion of the toner image due to the thickness of the toner image. Thus, Japanese Unexamined Patent Publication No. 10-83122, Japanese Unexamined Patent Publication No. 9-190090 and Japanese Unexamined Patent Publication No. 10-240020 propose that a comparatively thick elastic layer is formed on an intermediate transfer belt, enabling the elastic layer to absorb the thickness of the toner image, and thus the occurrence of stress concentration at the toner image is suppressed.

### SUMMARY OF THE INVENTION

An object of the present invention is to provide a toner for a developer, which can realize good tone and good developability by improving a shape of toner particles without adjusting the process.

An aspect of the present invention is directed to a toner for a developer comprising cylindrical toner particles formed of a toner composition containing at least a binder resin and a releasant as toner components, and an external additive, wherein the cylindrical toner particles have an average circularity of 0.880 or more and 0.930 or less.

An another object of the present invention is to provide a toner for a developer which can be produced with good productivity by a melt blown method and is uniform in characteristics such as fixing properties at low temperature and anti-offset properties, and is also excellent in fixing properties at low temperature and may not cause various problems involved in exposure of a wax even when used repeatedly for formation of an image for a long period.

Another aspect of the present invention pertains to a toner for a developer, containing the cylindrical toner particles, wherein the toner has an inclination value, Sυ, of melt viscosity-temperature characteristics measured by a flow tester, the value being 1×10⁴ Pa·S/° C. or lower.

A still another object of the present invention is to provide a toner for development of an electrostatic latent image, which can realize reduction of faulty cleaning by improving the shape of toner particles.

Still another aspect of the present invention is directed to a toner for a developer comprising toner particles in the form of an elliptical body formed by subjecting the cylindrical toner particles to a surface processing treatment, and an external additive.

A further object of the present invention is to provide a toner for a developer which forms uniform thin layers on the surface of a developer supporting material when used as a non-magnetic one-component developer, thereby making it possible to improve image quality of the formed image, or a toner for a developer which can improve image quality of the formed image when used as a two-component developer after mixing with a carrier, each toner for a developer capable of continuously forming a stable good image without deteriorating image quality even when used repeatedly for image formation for a long period.

A further aspect of the present invention pertains to a toner for a developer comprising the above cylindrical toner particles, and an external additive containing silica having a primary particle size of 10 to 25 nm and a charge amount of 300 to 600 μC/g.

A still further object of the present invention is to provide an improved toner for a developer used in an image forming apparatus which can suppress the occurrence of a void phenomenon and also can suppress the occurrence of distortion and color shift to a transfer image.

A still further aspect of the present invention pertains to a toner for a developer, containing the cylindrical toner particles, which is used in an image forming apparatus equipped with an intermediate transfer belt having a thickness of 300 μm or less.

Objects, features, aspects and advantages of the present invention become more apparent from the following detailed description and accompanying drawings.

### BRIEF DESCRIPTION OF THE DRAWINGS

FIG. 1 is a schematic view showing an example of a constitution of an image forming mechanism in which an image is formed using a developer (a magnetic two-component developer in FIG. 1) containing the toner for a developer according to one embodiment of the present invention.

FIG. 2 is a schematic view showing an example of a kneading step and a fiberizing step in a process for production of the cylindrical toner particles according to one embodiment of the present invention.

FIG. 3 is a schematic view showing an example of a cutting step in a process for production of the cylindrical toner particles according to one embodiment of the present invention.

FIG. 4 is a schematic view showing the cylindrical toner particle according to one embodiment of the present invention.

FIG. 5 is a schematic view showing the toner particle in the form of an elliptical body according to one embodiment of the present invention which is formed by subjecting the cylindrical toner particles to a spheroidization treatment.

FIG. 6 is a schematic view showing the cylindrical toner particle according to one embodiment of the present invention.

FIG. 7 is a schematic view showing an example of a main constitution of an image forming apparatus using the cylindrical toner particles according to one embodiment of the present invention.

FIG. 8 is a sectional view showing an intermediate transfer belt in an image forming apparatus using the cylindrical toner particles according to one embodiment of the present invention

### DETAILED DESCRIPTION OF THE INVENTION

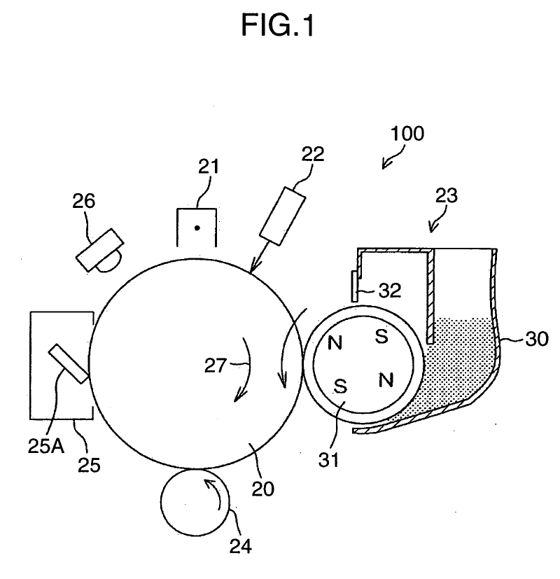

First, an image forming mechanism in which an image is formed using a developer containing the toner for a developer according to the present embodiment will be described in detail with reference to FIG. 1.

FIG. 1 is a schematic view showing an example of a constitution of an image forming mechanism in which an image is formed using a developer containing the toner for a developer according to the present embodiment. In FIG. 1, a magnetic two-component developer containing the toner for a developer and a magnetic carrier is used.

An image forming mechanism 100 includes a cylindrical image supporting material 20, a charger 21 for charging the surface of the image supporting material 20, an exposure device 22 for exposing the surface of the image supporting material 20 charged with the charger 21 according to an image to be formed, a developing apparatus 23 for supplying a magnetic two-component developer to the image supporting material 20 on which an electrostatic latent image is formed by exposure, a transfer device 24 for transferring a toner image formed on the surface of the image supporting material 20 onto a paper, a cleaning device 25 for removing the toner left on the surface of the image supporting material 20 after transferring the toner image onto the paper, and a destaticizing device 26 for destaticizing the surface of the photoconductor drum 2 after transferring the toner image. The charger 21, the exposure device 22, the developing apparatus 23, the transfer device 24, the cleaning device 25 and the destaticizing device 26 are sequentially arranged along a rotation direction (direction indicated by arrow 27) of the image supporting material 20.

The developing apparatus 23 is equipped with a developing tank 30 for enhancing the magnetic two-component developer. In the developing tank 30, a cylindrical developer supporting material 31 is rotatably attached so as to face the image supporting material 20. The developer supporting material 31 is formed into a magnet roller having a magnetic pole and therefore a magnetic brush composed of a magnetic two-component developer is formed on the peripheral surface of the developer supporting material 31.

The developing apparatus 23 is also equipped with a developer thickness regulating plate 32 for regulating the thickness of the magnetic two-component developer adhered onto the peripheral surface of the developer supporting material 31 in the form of a magnetic brush. The developer thickness regulating plate 32 is disposed while maintaining a fixed gap with the surface of the developer supporting material 31. Therefore, when the magnetic two-component developer passes through the developer thickness regulating plate 32, the toner and the magnetic carrier cause friction and the toner is charged. When the magnetic brush is brought into contact with the surface of the image supporting material 20, the toner in the magnetic brush adheres onto the image supporting material 20 to form a toner image on the image supporting material 20. Consequently, the electrostatic latent image supported on the image supporting material 20 is developed. The magnetic carrier is not consumed by development and is recovered by the developing tank 30, and the magnetic carrier is used after mixing with the toner again.

The cleaning device 25 is equipped with a cleaning blade 25A for scraping the toner adhered onto the peripheral surface of the image supporting material 20 while being in contact with the peripheral surface of the image supporting material 20.

The toner for a developer according to the present embodiment includes cylindrical toner particles and an external additive, the cylindrical toner particles being formed by transforming a toner composition containing at least a binder resin and a releasant into a molten state and by drawing the molten toner composition into a cylindrical fiber, followed by cutting the cylindrical fiber to the particles.

The method for forming the cylindrical toner particles according to the present embodiment will now be described. The cylindrical toner particles are prepared by the following method referred to as a melt blown method. The melt blown method is described in detail, for example, in Japanese Unexamined Patent Publication No. 2006-106236.

In the melt blown method, a kneading step of transforming the toner composition containing a binder resin, a releasant and a colorant as toner components into a molten state and kneading the molten toner composition; a fiberizing step of forming the molten toner composition kneaded in the molten state into a form of a fiber; and a cutting step of cutting the fiber-like toner composition into particles are sequentially carried out.

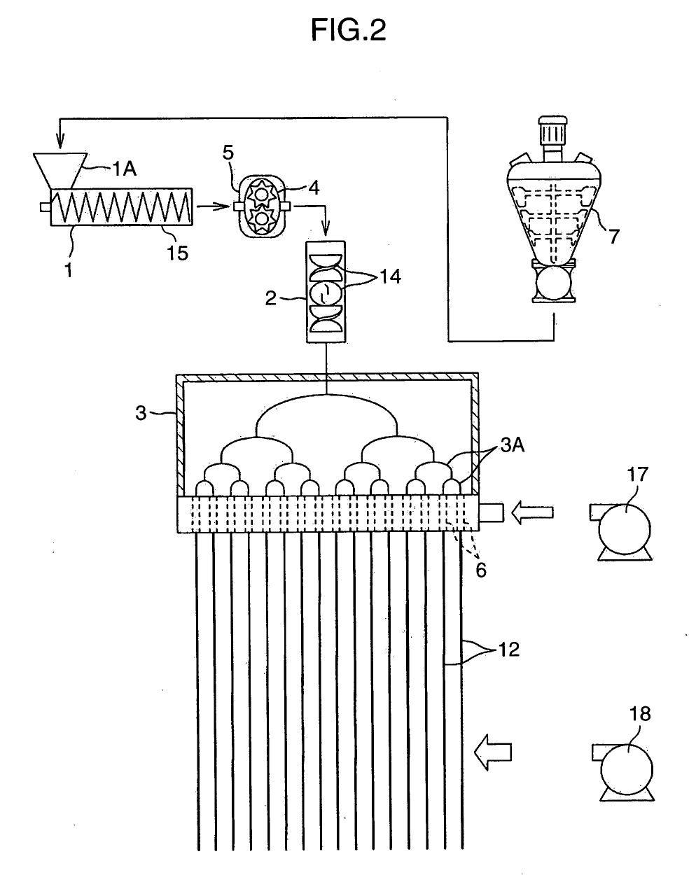

As shown in FIG. 2, the toner composition containing the toner components are kneaded using an extruder 1 in the kneading step. The toner composition include a binder resin, a releasant, a colorant and a charge control agent and these toner components are supplied to a premixing device (for example, Cyclomix manufactured by Hosokawa Micron Corporation) 7 and, after premixing, the premix is supplied to the extruder 1 through a hopper 1A. The extruder 1 is equipped with a heater (not shown) for heating the toner components, and is also equipped with a rotary screw 15 as a kneading member for kneading the toner components. The toner components supplied to the extruder 1 are transformed into a molten state by heating using the heater and the molten toner composition is kneaded by the rotary screw 15 at a predetermined temperature (for example, 140° C.). The extruder 1 is connected to a static mixer 2 through a gear pump and the molten toner composition kneaded by the extruder 1 is supplied to the static mixer 2.

The static mixer 2 includes multiple blades 14 composed of a twisted curved surface, in which a spiral flow passage is formed by the multiple blades 14. The molten toner composition kneaded by the extruder 1 is further kneaded by rotation of the blades 14. Consequently, the respective toner components are dispersed uniformly and finely in the static mixer 2. In the static mixer 2, the molten toner composition is maintained at a temperature which is higher than the kneading temperature (for example, 180° C.). The gear pump 4 is used for adjusting the amount of the molten toner composition to be extruded through nozzles 6 described hereinafter, and is driven by a motor 5. The kneading step is followed by the fiberizing step.

To the static mixer 2, a flow passage structure 3 including a multi-stage distributed flow passage 3A is connected. The molten toner composition is supplied to the distributed flow passage 3A from the static mixer 2, heated to a higher temperature (for example, 215° C.) by a heater (not shown) disposed in the flow passage structure 3, and then extruded through nozzles 6 provided at flow passage outlets of the respective distributed flow passages 3A.

The molten toner composition extruded through the respective nozzles 6 is in the form of a fiber and the fiber-like molten toner composition extruded through the nozzles 6 is drawn by hot air (for example, at about 215° C.) blown from an air blowing device for drawing 17 and then quickly cooled by cool air blown from an cool air blowing device 18 to form a fiber-like toner composition 12.

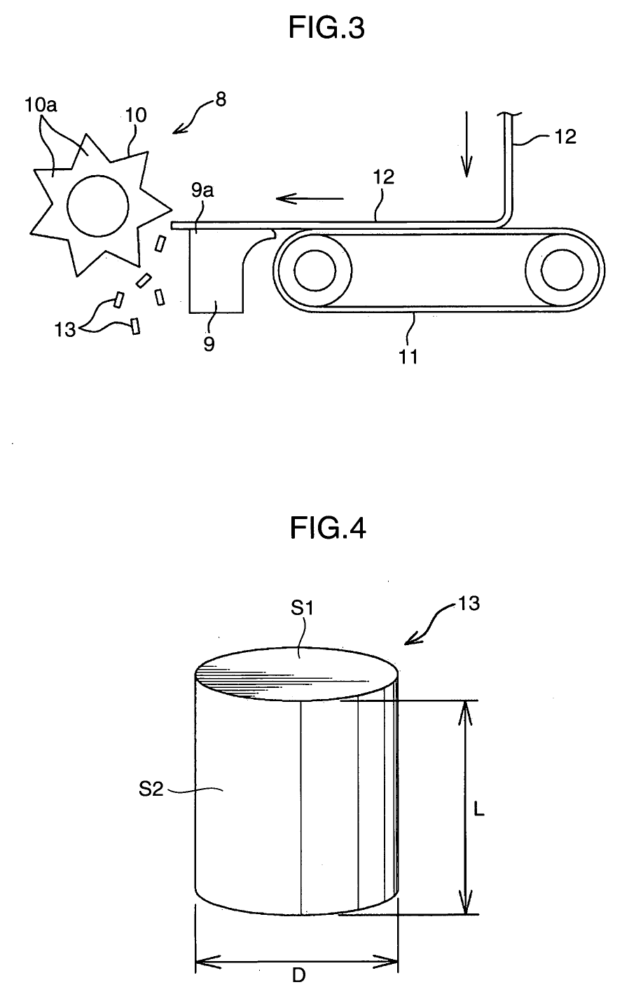

The cutting step of cutting the fiber-like toner composition 12 thus formed will now be described. As shown in FIG. 3, the fiber-like toner composition 12 thus formed is conveyed to a cutting device 8 using a conveying device 11. The cutting device 8 is equipped with a stationary knife 9 extending in a direction intersecting perpendicularly to the conveying direction of the fiber-like toner composition 12 to be conveyed on the conveying device 11, and a rotary knife 10 which is rotation-driven by a motor (not shown). When the fiber-like toner composition 12 is continuously supplied between the stationary knife 9 and the rotary knife 10, the fiber-like toner composition 12 is sequentially cut by a shearing action produced between an edge 9a of the stationary knife 9 and a cutter blade 10a of the rotary knife 10 to continuously produce cylindrical toner particles 13.

The length L (see FIG. 4) of the cylindrical toner particle 13 can be adjusted by the ratio of the conveying speed of the fiber-like toner composition 12 to the rotary speed of the rotary knife 10. Also, the cross-sectional diameter D (see FIG. 4) of the cylindrical toner particle 13 depends on the inner diameter of the discharge ports of the nozzles 6.

To the cylindrical toner particles 13 obtained by the method described above, an external additive is added, followed by mixing in a Henschel mixer (manufactured by Mitsui Mining Co., Ltd.) to obtain the toner for a developer of the present embodiment. The external additive is used for improving fluidity of the toner and has a particle size of tens of nanometers to hundreds of nanometers.

The toner for a developer of the present embodiment includes the cylindrical toner particles formed of the toner composition containing toner components, and the external additive, as described above. The cylindrical toner particles have an average circularity of 0.880 or more and 0.930 or less.

The average circularity is determined by the following procedure. Namely, measurement is conducted under an atmosphere at 23° C. and 60% RH using a flow particle image analyzer (FPIA-2100 manufactured by Sysmex Corporation) and a circularity (a) of the measured particle is determined by the following equation (1). The value obtained by dividing the sum total of circularities of the measured entire particles by the number of particles is defined as the average circularity:

a=L₀/L (1)

where L₀ denotes the peripheral length of a circle having the same projection area as that of the projection image of the particle, and L denotes the peripheral length when the projection image of the particle is subjected to image processing at a resolution of image processing of 512×512 (a picture element measuring 0.3 μm×0.3 μm).

When the average circularity of the cylindrical toner particles is less than 0.880, adhesion between the cylindrical toner particles and the magnetic carrier decreases, and thus the toner and the magnetic carrier are easily separated to cause scattering of the toner. On the other hand, when the average circularity is more than 0.930, adhesion between the cylindrical toner particles and the magnetic carrier increases, and thus movement of the toner to the image supporting material is inhibited. Also, the toner passes through the cleaning device and cleaning properties are deteriorated.

Namely, by controlling the average circularity of the cylindrical toner particles to 0.880 or more and 0.930 or less, adhesion between the cylindrical toner particles and the magnetic carrier can be properly maintained and the toner satisfactorily moves toward the image supporting material. As a result, excellent tone and developability are obtained.

In order to adjust the average circularity of the cylindrical toner particles to 0.880 or more and 0.930 or less, conditions of the cutting step such as conveying speed of the fiber-like toner composition and rotary speed of the rotary knife may be appropriately adjusted by increasing or decreasing the diameter of the discharge ports of the nozzles.

The standard deviation (SD value) of particle size distribution of the cylindrical toner particles contained in the toner for a developer of the present embodiment is preferably 1.20 μm or less.

The standard deviation (SD value) is the standard deviation based on a volume average particle size and is represented by the following equations:

$$\begin{matrix}S . D . = \sqrt{V} & ( 2 ) \\ V = \frac{{\sum }_{i = 1}^{n} {( {X}_{i} - \overline{X} )}^{2}}{n} & ( 3 )\end{matrix}$$

In equation 3, n represents the number of the toner particles measured, Xᵢ (i=1, 2, 3, . . . , n) represents the particle size of the toner particle, and

X̅

represents the volume average particle size.

When the standard deviation of particle size distribution of the cylindrical toner particles contained in the toner for a developer is more than 1.20 μm, the size of the toner particles becomes non-uniform and thus the proportion of overcharged or faulty-charged toners increases, resulting in unevenness of the charge amount of the respective toner particle. As a result, tone and developability are deteriorated.

When the standard deviation of particle size distribution of the cylindrical toner particles is 1.20 μm or less, comparatively sharp particle size distribution is attained, that is, the size of toner particles becomes uniform. Therefore, in the case of friction charging, the charge amount of the respective toner particle becomes nearly uniform. Consequently, excellent tone and developability can be realized.

In order to set the standard deviation of particle size distribution of the cylindrical toner particles to 1.20 μm or less, the cutting step may be controlled stably by making the conveying speed of the fiber-like toner composition or the rotary speed of the rotary knife stable.

A schematic view of the cylindrical toner particle according to the present embodiment is shown in FIG. 4. The cylindrical cross-sectional diameter D of the cylindrical toner particle is preferably selected within a range from 2.5 to 10 μm. For example, when the cylindrical cross-sectional diameter D is 5.0 μm, the cylindrical length L of the cylindrical toner particle is preferably 5.0 μm or more and 10.0 μm or less. That is, the value L/D obtained by dividing the cylindrical length by the cylindrical cross-sectional diameter is preferably 1.0 or more and 2.0 or less.

The value L/D obtained by dividing the cylindrical length by the cylindrical cross-sectional diameter of the cylindrical toner particles is determined by the following procedure. Namely, an image at 2,000 times magnification of the cylindrical toner particles was taken under a scanning electron microscope (SEM). At this time, 100 cylindrical toner particles were extracted at random from the image and then the cylindrical length and the cylindrical cross-sectional diameter of the respective cylindrical toner particle were measured. Then, the averages of the cylindrical length L and of the cylindrical cross-sectional diameter D were determined. In the case where the cut surface does not intersect perpendicularly to the central axis of the cylindrical toner (in the case where the cut surface is inclined or curved), the axis length of the central axis is referred to as the cylindrical length L.

When the value L/D obtained by dividing the cylindrical length by the cylindrical cross-sectional diameter of the cylindrical toner particle is less than 1.0, the proportion of the cut surface S1 relative to the entire external surface of the cylindrical toner particle 13 is large and thus the cylindrical toner particles are likely to adhere to the carrier on this cut surface S1, resulting in excessively strong adhesion between the cylindrical toner particles and the magnetic carrier. Therefore, it becomes difficult for the toner to move toward the image supporting material. On the other hand, when the value L/D obtained by dividing the cylindrical length by the cylindrical cross-sectional diameter is more than 2.0, the proportion of the peripheral surface S2 relative to the entire external surface of the cylindrical toner particle is large and thus the cylindrical toner particles are likely to adhere to the magnetic carrier on the peripheral surface S2, resulting in excessively strong adhesion between the cylindrical toner particles and the magnetic carrier. Therefore, it becomes difficult for the toner to move toward the image supporting material. Consequently, tone and developability are deteriorated.

In the toner for a developer of the present embodiment, since the value L/D obtained by dividing the cylindrical length by the cylindrical cross-sectional diameter of the cylindrical toner particle is 1.0 or more and 2.0 or less, adhesion between the cylindrical toner particles and the magnetic carrier can be properly maintained. Therefore, it becomes possible that the toner satisfactorily moves toward the image supporting material. Thus, excellent tone and developability can be realized.

In order to set the value L/D obtained by dividing the cylindrical length by the cylindrical cross-sectional diameter to 1.0 or more and 2.0 or less, conditions of the cutting step such as conveying speed of the fiber-like toner composition and rotary speed of the rotary knife may be appropriately adjusted by increasing or decreasing the diameter of the discharge ports of the nozzles 6.

Furthermore, the average circularity of the cylindrical toner particles is preferably 0.890 or more and 0.920 or less.

When the average circularity of the cylindrical toner particles is less than 0.890, there arises a problem that adhesion between the cylindrical toner particles and the magnetic carrier becomes too weak and thus the toner and the magnetic carrier are simply separated, resulting in scattering of the toner. In contrast, when the average circularity of the cylindrical toner particles is more than 0.920, adhesion between the cylindrical toner particles 13 and the magnetic carrier becomes too strong and thus it becomes difficult for the toner to move toward the image supporting material. Also, when the circularity is more than 0.920, the toner passes through the cleaning device and cleaning properties are deteriorated.

When the average circularity of the cylindrical toner particles is 0.890 or more and 0.920 or less, adhesion between the cylindrical toner particles and the magnetic carrier can be properly maintained. Therefore, it becomes possible that the toner properly moves toward the image supporting material. Thus, excellent tone and developability can be realized.

In order to set the average circularity of the cylindrical toner particles to 0.890 or more and 0.920 or less, conditions of the cutting step such as conveying speed of the fiber-like toner composition and rotary speed of the rotary knife may be appropriately adjusted by increasing or decreasing the diameter of the discharge ports of the nozzles 6.

The toner for a developer of the present embodiment includes the cylindrical toner particles formed of the toner composition containing toner components, as described above, and the toner for a developer preferably has an inclination value, Sυ, of melt viscosity-temperature characteristics measured by a flow tester, the value being 1×10⁴ Pa·S/° C. or lower.

The present inventors have studied and found the following. That is, in the melt blown method, when the toner composition is drawn into a cylindrical fiber during the drawing step, a molten state must be maintained by heating to a temperature which is higher than that in the kneading step. When the viscosity of the toner composition in the molten state decreases excessively, a wax as a toner component dispersed finely in the toner composition during the kneading step is aggregated again to cause various problems. That is, when the wax is aggregated again in the toner composition and the dispersion diameter increases, there arises a problem that the cylindrical fiber is likely to be broken during the drawing step and thus productivity of the toner particles is deteriorated. Also, since the amount of the wax contained in the individual toner particle produced by finely cutting the cylindrical fiber during the cutting step drastically varies, fixing properties at low temperature of the toner particles or characteristics capable of preventing the occurrence of offset at a low temperature by raising the temperature at which offset arises, namely, anti-offset properties may drastically vary. Also, since the exposed area of the wax increases in the cut surface of the cylindrical fiber, there may arise various problems involved in exposure of the wax in the prior art.

In the present embodiment, since the toner particles are formed using the toner composition whose viscosity scarcely decreases upon melting so that the inclination value, Sυ, of melt viscosity-temperature characteristics of the toner for a developer becomes 1×10⁴ Pa·S/° C. or lower, it is possible to suppress an increase in the dispersion diameter as a result of reaggregation of the wax during the drawing step which is otherwise dispersed finely in the toner composition during the kneading step in the production of the toner particles using the melt blown method, thereby enabling to maintain a state where the wax is finely dispersed.

In the present embodiment, when the inclination value Sυ of melt viscosity-temperature characteristics of the toner for a developer is more than 1×10⁴ Pa·S/° C., the viscosity upon melting of the toner composition excessively decreases in the production of the toner particles by the melt blown method, and thus it becomes difficult to suppress an increase in the dispersion diameter of the wax as a result of reaggregation during the drawing step which is otherwise dispersed finely in the toner composition during the kneading step.

There are no restrictions on the lower limit of the inclination value Sυ. However, the inclination value Sυ is preferably 0.8×10⁴ Pa·S/° C. or more considering that productivity of the toner particles is improved by drawing the toner composition into a cylindrical fiber as smoothly as possible during the drawing step. Considering both ease of drawing and the effect of preventing reaggregation of the wax, the inclination value Sυ is more preferably within a range from 0.85×10⁴ to 0.95×10⁴ Pa·S/° C.

The inclination value Sυ of melt viscosity-temperature characteristics is represented by the value determined by the following method.

### (Method for Calculation of Inclination Value Sυ)

1.8 g of an electrophotographic toner whose inclination value Sυ is to be determined is filled in a mold for compression molding, having an inner diameter corresponding to an inner diameter of a cylinder of a flow tester used for measurement, followed by compression molding under a pressure of 1,000 kg/cm² to produce a tablet-shaped measuring sample.

Then, the resulting sample is encased in the cylinder of the flow tester and the temperature of the cylinder is gradually raised while applying a fixed load on the sample in the cylinder according to the measuring method described in Japanese Industrial Standard JIS K7210: 1999 “Test Method of Melt Mass Flow Rate (MFR) and Melt Volume Flow Rate (MVR) of Thermoplastic Plastic/Plastic”. Subsequently, the change in the flow rate in the case where the sample is melted and flows out of the cylinder through a die provided on the bottom of the cylinder is measured, and the change in the melt viscosity with the temperature rise is determined from the measured flow rate value, and then a graph of melt viscosity-temperature characteristics is made.

From the graph of the relationship between the melt viscosity and the temperature characteristics, a melt viscosity υ₁ (Pa·S) at a temperature T₁ (° C.), which is the temperature at which the molten sample begins to flow out through the die plus 5° C., and a melt viscosity υ₂ (Pa·S) at a temperature T₂ (° C.), which is the temperature at which the entire sample flows out and flowing out is completed minus 5° C., are determined, and then an inclination value Sυ of melt viscosity-temperature characteristics was calculated from the formula (4):

$$Sv = \frac{{v}_{1} - {v}_{2}}{{T}_{2} - {T}_{1}} \qquad ( 4 )$$

In order to adjust the inclination value Sυ within the above range, for example, kinds and proportions of the respective toner components constituting the toner composition may be adjusted. Particularly, in a binder resin as the toner component, it is effective for adjusting the inclination value Sυ of melt viscosity-temperature characteristics within the above range to use the binder resin having at least two weight average molecular weight peaks in the molecular weight distribution and to adjust the proportion of each peak. In order to adjust the proportion of each peak, it is preferred to mix two or more same kinds of binder resins or different kinds of compatible binder resins, each having a weight average molecular weight corresponding to the weight average molecular weight of each peak, in a proportion corresponding to the proportion of each peak.

The binder resin as one of the toner components constituting the toner composition of the present embodiment will now be described.

Examples of the binder resin include conventionally known various thermoplastic resins, for example, a styrenic resin; an acrylic resin; a styrene-acrylic resin; an olefinic resin such as polyethylene, polypropylene or an ionomer; a vinyl chloride-based resin; a polyester-based resin; a polyamide-based resin; a polyurethane-based resin; a polyvinyl alcohol-based resin; a vinylether-based resin; a N-vinyl-based resin such as poly-N-vinyl pyrrolidone or poly-N-vinylcarbazole; and a styrene-butadiene-based resin, and these binder resins are used alone or in combination. Of these binder resins, a styrenic resin, a styrene-acrylic resin and a polyester-based resin are preferred. Examples of the styrenic resin and styrene-acrylic resin include a homopolymer of styrene, and a copolymer of styrene and another monomer.

Examples of the monomer which is copolymerizable with styrene include p-chlorostyrene; vinyl naphthalene; ethylene unsaturated monoolefins such as ethylene, propylene, butylene and isobutylene; vinyl halides such as vinyl chloride, vinyl bromide and vinyl fluoride; vinyl esters such as vinyl acetate, vinyl propionate, vinyl benzoate and vinyl butyrate; (meth)acrylate esters such as methyl acrylate, ethyl acrylate, n-butyl acrylate, isobutyl acrylate, dodecyl acrylate, n-octyl acrylate, 2-chloroethyl acrylate, phenyl acrylate, α-chloromethyl acrylate, methyl methacrylate, ethyl methacrylate and butyl methacrylate; other acrylic acid derivatives such as acrylonitrile, methacrylonitrile and acrylamide; vinyl ethers such as vinyl methyl ether and vinyl isobutyl ether; vinyl ketones such as vinyl methyl ketone, vinyl ethyl ketone and methyl isopropenyl ketone; and N-vinyl compounds such as N-vinylpyrrole, N-vinylcarbazole, N-vinylindole and N-vinyl pyrrolidene. These monomers may be used alone, or two or more kinds of them may be used in combination.

As the styrenic resin, any styrenic resin having an arbitrary molecular weight can be used. However, as described above, in order to adjust the inclination value Sυ, it is preferred to use a styrenic resin having two or more weight average molecular weight peaks in the molecular weight distribution, the proportion of each peak being adjusted. It is particularly preferred to use a styrenic resin in which a weight average molecular weight peak at a low molecular weight side (hereinafter referred to as a “low molecular weight peak”) is within a range from 3,000 to 20,000 and a weight average molecular weight peak at a high molecular weight side (hereinafter referred to as a “high molecular weight peak”) is within a range from 300,000 to 1,500,000, the styrenic resin having a molecular weight distribution with the ratio of the weight average molecular weight Mw to the number average molecular weight Mn, Mw/Mn, of 10 or more.

As described above, when using the styrenic resin with the above molecular weight distribution, by adjusting the proportion of both peaks, not only the inclination value Sυ of melt viscosity-temperature characteristics of the toner component can be easily adjusted to 1×10⁴ Pa·S/° C. or lower, but also characteristics capable of fixing onto the surface of a material to be printed such as paper at a lower temperature, that is, fixing properties at low temperature can be improved by decreasing the fixing temperature of the toner particles using the low molecular weight component, and also characteristics capable of preventing the occurrence of offset at a lower temperature, namely, anti-offset properties can be improved by raising the temperature at which offset occurs. The molecular weight of the styrenic resin can be determined by GPC (gel permeation chromatography). For example, the molecular weight can be determined from a calibration curve which is preliminarily obtained using a standard polystyrene resin after measuring the time of elution from the column using THF (tetrahydrofuran) as a solvent in a molecular weight measuring device HLC-8220 manufactured by Tosoh Corporation.

For the polyester-based resin as the binder resin, for example, those obtained by polycondensing a polyvalent carboxylic acid component with a polyvalent alcohol component can be used. Examples of the polyvalent carboxylic acid component include divalent carboxylic acids such as maleic acid, fumaric acid, citraconic acid, itaconic acid, glutaconic acid, phthalic acid, isophthalid acid, terephthalic acid, cyclohexanedicarboxylic acid, succinic acid, adipic acid, sebacic acid, azelaic acid and malonic acid; alkyl or alkenyl esters of divalent carboxylic acids, such as n-butylsuccinic acid, n-butenylsuccinic acid, isobutylsuccinic acid, isobutenylsuccinic acid, n-octylsuccinic acid, n-octenylsuccinic acid, n-dodecylsuccinic acid, n-dodecenylsuccinic acid, isododecylsuccinic acid and isododecenylsuccinic acid; and tri- or higher-valent carboxylic acids such as 1,2,4-benzenetricarboxylic acid (trimellitic acid), 1,2,5-benzenetricarboxylic acid, 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylenecarboxypropane, 1,2,4-cyclohexanetricarboxylic acid, tetra(methylenecarboxyl)methane, 1,2,7,8-octantetracarboxylic acid, pyromellitic acid and enpol trimer. Also, anhydrides and lower alkyl esters of these polyvalent carboxylic acids are used.

Examples of the polyvalent alcohol component include diols such as ethylene glycol, diethylene glycol, triethylene glycol, 1,2-propyleneglycol, 1,3-propylene glycol, 1,4-butanediol, neopentyl glycol, 1,4-butenediol, 1,5-pentanediol, 1,6-hexanediol, 1,4-cyclohexanedimethanol, dipropylene glycol, polyethylene glycol, polypropylene glycol and polytetramethylene glycol; bisphenols, such as bisphenol A, hydrogenated bisphenol A, polyoxyethylenated bisphenol A and polyoxypropylenated bisphenol A; and tri- or higher-valent alcohols such as sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, diglycerol, 2-methylpropanetriol, 2-methyl-1,2,4-butanetriol, trimethylolethane, trimethylolpropane and 1,3,5-trihydroxymethylbenzene.

As to the polyester-based resin, considering that the binder resin is satisfactorily fixed onto the surface of a material to be printed such as paper by thermal fixing means used in a conventional image forming apparatus, the softening point is preferably from 110 to 150° C., and particularly preferably from 120 to 140° C. In order to adjust the inclination value Sυ of melt viscosity-temperature characteristics of the toner for a developer containing the polyester-based resin as the binder resin to 1×10⁴ Pa·S/° C. or lower, in a similar way as the case of the styrenic resin, it is preferred to use a polyester-based resin which has at least two weight average molecular weight peaks in molecular weight distribution, the proportion of each peak being adjusted. It is particularly preferred to use a polyester-based resin which has a low molecular weight peak within a range from 3,000 to 5,000 and a high molecular weight peak within a range from 50,000 to 100,000.

Considering that the toner particles are fixed onto the surface of a material to be printed such as paper as satisfactorily as possible, that is, fixing properties are to be improved, the binder resin such as the styrenic resin or the polyester-based resin is preferably a thermoplastic resin, but a portion thereof may have a cross-linked structure.

By partially introducing the cross-linked structure, it is possible to improve storage stability, shape retention, and durability, namely, the effect of preventing the occurrences of so-called blocking caused by bulky fusion of a lot of toner particles and deformation of individual toner particle when the toner particles are stored for a long period, without deteriorating fixing properties of the toner particles. The content of the cross-linked portion is not specifically limited, but is preferably 10% by mass or less, and particularly preferably from 0.1 to 10% by mass, in terms of the content of a gel fraction determined by extracting the binder resin using a Soxhlet extractor. In order to convert a portion of the binder resin into the cross-linked structure, the resin may be cross-linked by adding a cross-linking agent or a thermosetting resin may be added.

Examples of the thermosetting resin include epoxy-based resins such as a bisphenol A type epoxy resin, a hydrogenated bisphenol A type epoxy resin, a novolak type epoxy resin, a polyalkylene ether type epoxy resin and a cyclic aliphatic epoxy resin, and a cyanate-based resin. These thermosetting resins may be used alone, or two or more kinds of them may be used in combination. The binder resin is preferably a resin having a functional group such as a hydroxyl group, a carboxyl group, an amino group or a glycidoxy (epoxy) group in the molecule so as to improve dispersibility of other toner components such as a colorant, a wax and a charge control agent. It can be confirmed using a FT-IR device whether or not the binder resin has these functional groups, and also the amount of these functional groups can be determined using a titration method.

The glass transition point (Tg) of the binder resin is preferably within a range from about 55 to 70° C. When the glass transition point of the binder resin is lower than 55° C., the resulting toners may be blocked, thereby deteriorating storage stability. Also, since the resin has a low strength, there may arise toner adhesion in which the toner adheres onto the surface of a latent image supporting material and is not removed from the surface. In contrast, when the glass transition point of the binder resin is higher than 70° C., fixability of the toner onto the surface of a material to be printed such as paper may become inferior. The glass transition temperature of the binder resin can be determined from the change point of the specific heat in an endothermic curve measured using a differential scanning calorimeter (DSC). For example, the glass transition temperature can be determined by the following procedure. As a example, 10 mg of a measuring sample is placed in an aluminum pan and measurement is performed at a measuring temperature within a range from 25 to 200° C. and a temperature raising rate of 10° C./min using a differential scanning calorimeter DSC-6200 manufactured by Seiko Instruments Inc. as the measuring device and using a vacant aluminum pan as the reference. The glass transition point can be determined from the change point of the resulting endothermic curve.

The releasant as the other toner component constituting the toner composition of the present embodiment will now be described.

As described previously, when the viscosity of a toner composition in a molten state decreases excessively in the above melt blown method, a wax as a releasant dispersed finely in the toner composition during the kneading step is aggregated again to cause various problems. These problems remarkably arise when using a wax having a low melting point so as to improve fixing properties at low temperature of toner particles. Therefore, in a conventional electrophotographic toner containing toner particles produced by a melt blown method, there may arise a problem that fixing properties at low temperature of the toner particles cannot be improved by decreasing the fixing temperature using a wax having a low melting point.

In the toner for a developer of the present embodiment, the inclination value Sυ of melt viscosity-temperature characteristics measured by a flow tester is preferably 1×10⁴ Pa·S/° C. or lower and also the melting point of the wax as the releasant is preferably 100° C. or lower.

In the present embodiment, since the toner particles are formed using the toner composition whose viscosity scarcely decreases upon melting so that an inclination value Sυ of melt viscosity-temperature characteristics of the toner for a developer becomes 1×10⁴ Pa·S/° C. or lower, despite the use of the wax having the low melting point of 100° C. or lower, it is possible to maintain a state where the wax is finely dispersed by suppressing an increase in the dispersion diameter caused by reaggregation of the wax during the drawing step which is dispersed finely in the toner composition during the kneading step in the production of the toner particles using the melt blown method.

Therefore, it is possible to improve productivity of the toner particles by suppressing easy breakage of the cylindrical fiber during the drawing step. It is also possible to reduce variation in fixing properties at low temperature and anti-offset properties by decreasing variation in the amount of the wax contained in the individual toner particles produced by finely cutting the cylindrical fiber during the cutting step. Furthermore, by decreasing the exposed area of the wax in the cut surface of the cylindrical fiber, it is also possible to suppress various problems involved in exposure of the wax even though the toner particles are repeatedly used for formation of the image for a long period. It is also possible to improve fixing properties at low temperature of the toner particles by using the wax having the low melting point of 100° C. or lower.

Examples of the wax, which serves as the anti-offset agent as described above, include waxes having a melting point of 100° C. or lower, for example, olefinic waxes such as polyethylene wax and polypropylene wax; vegetable waxes such as carnauba wax, rice wax, sugar wax, Japan wax and candelilla wax; mineral-based waxes such as montan wax; animal waxes such as beeswax, insect wax, whale wax and wool wax; petroleum-based waxes such as paraffin wax and microcrystalline wax; ester-based waxes; Teflon®-based waxes; and Fischer-Tropsch waxes synthesized from petroleum and natural gas using a Fischer-Tropsch method, and these waxes may be used alone or in combination.

When using at least two kinds of waxes in combination, it is ideal that all waxes used in combination have a melting point of 100° C. or lower. However, if the melting point in the combination is 100° C. or lower, the melting point of at least one kind of wax may be higher than 100° C. Considering that the wax is uniformly dispersed in the toner particles, the wax is preferably a wax having an ester on the side chain, for example, a polyethylene wax or a Fischer-Tropsch wax having an ester on the side chain. The wax preferably has a endothermic main peak within a range from 85 to 95° C. in an endothermic curve measured using a differential scanning calorimeter (DSC). When using a wax having an endothermic main peak of less than 85° C., the toner particles are likely to cause blocking and a so-called hot offset in which the toner particles are fixed onto a fixing roller in a molten state and thus a material to be printed such as paper is wound around the fixing roller. When using a wax having an endothermic main peak of higher than 95° C., good fixing properties at low temperature may not be obtained.

The amount of the wax is preferably from 0.1 to 20 parts by mass based on 100 parts by mass of the binder resin. When the amount is less than 0.1 parts by mass, the above effect of the addition of the wax may not be sufficiently obtained. In contrast, when the amount is more than 20 parts by mass, toner particles are likely to cause blocking and wax may be detached from the toner particles.

Examples of the other toner components constituting the toner composition include colorants.

As the colorant, colorants with various colors corresponding to the color of the toner particles can be used, and preferred examples thereof are as follows.

### (Black Pigment)

Carbon black such as acetylene black, lamp black and aniline black

### (Yellow Pigment)

Chrome Yellow, Zinc Yellow, Cadmium Yellow, Yellow Iron Oxide, Mineral Fast Yellow, Nickel Titanium Yellow, Nables Yellow, Naphthols Yellow S, Hansa Yellow G, Hansa Yellow 10G, Benzidine Yellow G, Benzidine Yellow GR, Quinoline Yellow Lake, Permanent Yellow NCG and Tartrazine Lake

### (Orange Pigment)

### Chrome Orange, Molybdenum Orange, Permanent Orange GTR, Pyrazolone Orange, Vulcan Orange, Indathrene Brilliant Orange RK, Benzidine Orange G and Indathrene Brilliant Orange GK

### (Red Pigment)

### Blood Red, Cadmium Red, Red Lead, Cadmium Mercury Sulfide, Permanent Red 4R, Lithol Red, Pyrazolone Red, Watching Red Calcium Salt, Lake Red D, Brilliant Carmine 6B, Eosine Lake, Rhodamine Lake B, Alizarin Lake and Brilliant Carmine 3B

### (Violet Pigment)

### Manganese Violet, Fast Violet B and Methyl Violet Lake

### (Blue Pigment)

Prussian Blue, Cobalt Blue, Alkali Blue Lake, Victoria Blue Lake, Phthalocyanine Blue, metal-free Phthalocyanine Blue, partially chlorinated Phthalocyanine Blue, Fast Skyblue and Indathrene Blue BC

### (Green Pigment)

### Chromium Green, Chromium Oxide, Pigment Green B, Malachite Green Lake and Final Yellow Green G

### (White Pigment)

zinc white, titanium oxide, antimony white and zinc sulfide

### (Extender Pigment)

barite powder, barium carbonate, clay, silica, white carbon, talc and alumina white

The amount of the colorant is preferably from 1 to 20 parts by mass, and particularly preferably from 2 to 8 parts by mass, based on 100 parts by mass of the binder resin.

The toner composition may contain, in addition to the toner components described above, various other additives. Examples of other additives include a charge control agent and a stabilizer.

The charge control agent is used to control friction-charged characteristics of the toner, and a charge control agent for positive charge control and/or a charge control agent for negative charge control are used according to the charge polarity of the toner.

Examples of the charge control agent of positively charging type include azine compounds such as pyridazine, pyrimidine, pyrazine, orthooxazine, methoxazine, paraoxazine, orthothiazine, meththiazine, parathiazine, 1,2,3-triazine, 1,2,4-triazine, 1,3,5-triazine, 1,2,4-oxadiazine, 1,3,4-oxadiazine, 1,2,6-oxadiazine, 1,3,4-thiadiazine, 1,3,5-thiadiazine, 1,2,3,4-tetrazine, 1,2,4,5-tetrazine, 1,2,3,5-tetrazine, 1,2,4,6-oxatriazine, 1,3,4,5-oxatriazine, phthalazine, quinazoline and quinoxaline; direct dyes composed of azine compounds, such as Azine Fast Red FC, Azine Fast Red 12BK, Azine Violet BO, Azine Brown 3G, Azine Light Brown GR, Azine Dark Green BH/C, Azine Deep Black EW and Azine Deep Black 3RL; nigrosin compounds such as nigrosin, a nigrosin salt and a nigrosin derivative; acidic dyes composed of nigrosin compounds, such as nigrosin BK, nigrosin NB and nigrosin Z; metal salts of naphthenic acid or higher fatty acids; alkoxylated amines; alkylamides; and quaternary ammonium salts such as benzylmethylhexyldecylammonium and decyltrimethylammonium chloride, and these charge control agent of positively charging type may be used alone or in combination. Of these charge control agents, nigrosin compounds are preferably used as the charge control agent of positively charging type because quicker charge rising characteristics are obtained.

As the charge control agent of positively charging type, for example, a resin or oligomer containing a quaternary ammonium salt, a resin or oligomer containing a carboxylate and a resin or oligomer containing a carboxyl group can also be used. Specific examples thereof include a polystyrenic resin containing a quaternary ammonium salt, an acrylic resin containing a quaternary ammonium salt, a styrene-acrylic resin containing a quaternary ammonium salt, a polyester-based resin containing a quaternary ammonium salt, a polystyrenic resin containing a carboxylate, an acrylic resin containing a carboxylate, a styrene-acrylic resin containing a carboxylate, a polyester-based resin containing a carboxylate, a polystyrenic resin containing a carboxyl group, an acrylic resin containing a carboxyl group, a styrene-acrylic resin containing a carboxyl group and a polyester-based resin containing a carboxyl group.

Of these charge control agents, a styrene-acrylic resin (a styrene-acrylic copolymer) containing a quaternary ammonium salt, a carboxylate salt or a carboxyl group as a functional group is preferred because the charge amount can be easily adjusted to a value within a predetermined range. Examples of the acrylic monomer, which constitutes the styrene-acrylic resin together with styrene, include alkyl (meth)acrylate esters such as methyl acrylate, ethyl acrylate, n-propyl acrylate, isopropyl acrylate, n-butyl acrylate, isobutyl acrylate, 2-ethylhexyl acrylate, methyl methacrylate, ethyl methacrylate, n-butyl methacrylate and isobutyl methacrylate.

Furthermore, as the quaternary ammonium salt compound, a unit derived from a dialkylaminoalkyl (meth)acrylate through a step of quaternization is used. As the dialkylaminoalkyl (meth)acrylate to be derived, for example, di (lower alkyl)aminoethyl (meth)acrylates such as dimethylaminoethyl (meth)acrylate, diethylaminoethyl (meth)acrylate, dipropylaminoethyl (meth)acrylate and dibutylaminoethyl (meth)acrylate; dimethylmethacrylamide; and dimethylaminopropylmethacrylamide are preferred. Also, it is possible to use in combination with a hydroxy group-containing polymerizable monomer such as hydroxyethyl (meth)acrylate, hydroxypropyl (meth)acrylate, 2-hydroxybutyl (meth)acrylate or N-methylol(meth)acrylamide upon polymerization.

As the charge control agent of negatively charging type, for example, an organic metal complex or a chelate compound is effective. Of these charge control agents of negatively charging type, an acetylacetone metal complex, or a salicylic acid-based metal complex or salt is preferred, and a salicylic acid-based metal complex or salt is particularly preferred. Examples of the acetylacetone metal complex include aluminum acetylacetonate and iron(II) acetylacetonate. Examples of the salicylic acid-based metal complex or salt include chrome 3,5-di-tert-butyl salicylate.

When the toner is a color toner, a colorless, white or pale charge control agent is preferably used so as not to exert an influence on a color tone. The amount of the charge control agent to be added is preferably from 0.5 to 10 parts by mass, and particularly preferably from 1 to 5 parts by mass, based on 100 parts by mass of the binder resin.

Other preferred embodiments of the present invention will now be described. The toner for a developer according to the another embodiment preferably contains, as the toner particles, toner particles in the form of an elliptical body formed by subjecting the cylindrical toner particles made of the toner composition containing the respective toner components to a surface processing treatment.

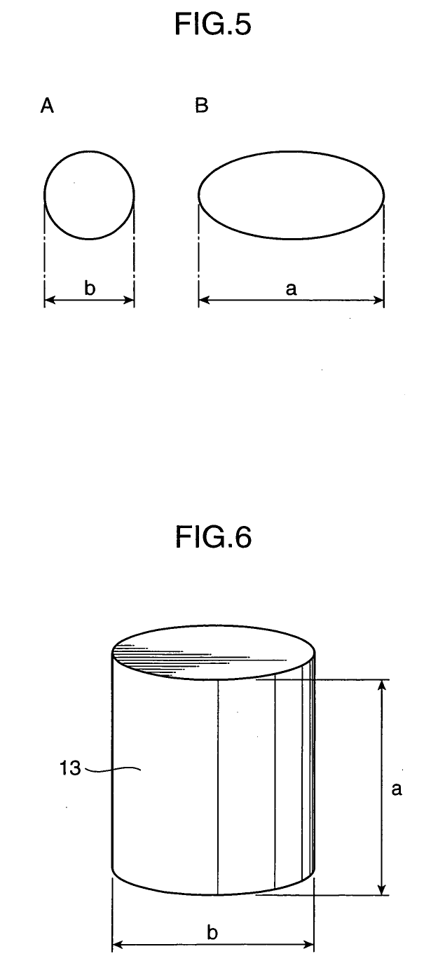

In the another embodiment above, the cylindrical toner particles are preferably produced by the melt blown method. As described previously, the melt blown method includes a melt-mixing step of melt-mixing the toner composition obtained by premixing the respective toner components; a fiberizing step of extruding the toner composition in a molten state obtained in the melt-mixing step through nozzle to form a fiber; and an atomizing step of cutting the fiber-like toner composition to form cylindrical toner particles. Then, the surface of the resulting cylindrical toner particles is subjected to a surface processing treatment to form toner particles in the form of an elliptical body. The surface processing treatment is not specifically limited as long as it is a surface processing treatment which enables formation of the toner particles in the form of an elliptical body having a shape described hereinafter by treating the surface of the cylindrical toner particle. The surface processing treatment includes, for example, a spheroidization treatment of spherodizing the surface of the cylindrical toner particle. For example, according to the spheroidization treatment, the toner particle in the form of an elliptical body (spheroid) having a major diameter a of 4 to 13 μm, a minor diameter b of 5 to 9 μm (a>b) (see FIG. 5) are produced through a spherodizing step of removing edges of the cylindrical toner particle obtained by the melt blown method to produce the toner particle in the form of an elliptical body.

In the spherodizing step, the toner particles in the form of an elliptical body are produced by a spheroidization treatment of removing edges of the cylindrical particles using a spherodizing device (for example, Faculty Model F-400, manufactured by Hosokawa Micron Corporation). Herein, an average circularity of the toner particles in the form of an elliptical body can be varied by adjusting a treating time by the spherodizing device.

Although the cylindrical particles having particle size distribution required to the toner can be produced by controlling a cut length in the above atomizing step, a classifying step may be optionally provided after the atomizing step. In case of providing the classifying step, classification can be conducted so as to adjust a ratio of a major diameter a to a minor diameter b within a predetermined range. Also, particle size distribution of the toner particles can be adjusted by controlling classification accuracy.

In FIG. 5, an example of a typical shape of the toner particle in the form of an elliptical body is shown. A in FIG. 5 shows a shape viewed from the direction in which a major axis of the toner particle extends, whereas, B shows a shape of the side of the elliptical body. As described above, the toner particle is produced by removing edges of the cylindrical particle, and is in the form of an elliptical body (spheroid) having a major diameter of a and a minor diameter of b, as shown in FIG. 5.

In the present embodiment, although an elliptical body free from distortion was described as a shape of the toner particle, the shape may be slightly distorted according to the manufacturing technique. The present embodiment also includes the distorted elliptical body. According to the manufacturing technique, the shape may be a bale having surfaces at both ends in a major axis extending direction and the present embodiment also include a bale-like shape.

In the toner particle in the form of an elliptical body, a and b preferably satisfy the following conditions: a is from 4 to 13 μm, b is from 5 to 9 μm, and a>b. As an example, an elliptical body having average values (a=6.5 μm, b=5 μm) was produced.

A value a/b obtained by dividing a major diameter a of the toner particle by a minor diameter b is preferably 1.0 or more and 2.0 or less. When the value a/b obtained by dividing a major diameter a of the toner particle by a minor diameter b exceeds 2.0, since the surface area of the toner particle excessively increases, physical adhesion of the toner increases and faulty cleaning increases.

When the value a/b obtained by dividing a major diameter a of the toner particle by a minor diameter b is 1.0 or more and 2.0 or less, the surface area of the toner particle does not excessively increase. Therefore, physical adhesion of the toner can be properly maintained and thus faulty cleaning can be reduced. In order to set the value a/b within the above range, conditions of the cutting step such as a conveying speed of the fiber-like toner composition and a rotary speed of the rotary knife may be appropriately adjusted. Also, the value a/b can be set within the above range by providing a classifying step after the atomizing step.

A standard deviation (SD value) of particle size distribution of the toner particles in the form of an elliptical body is preferably 1.00 μm or less. When the standard deviation of particle size distribution of toner particles exceeds 1.00 μm, the size of the toner particles becomes non-uniform and thus the proportion of overcharged or faulty-charged toners increases, resulting in unevenness of the charge amount of the respective toner particles.

Since particle size distribution of the toner particles is comparatively sharp in which the standard deviation is 1.00 μm or less, charge uniformity of the toner upon friction charging can be improved. Therefore, it becomes possible to control at a lower applied voltage upon transfer and the proportion of the overcharged toner can be decreased. Therefore, faulty cleaning can be reduced. In order to set the standard deviation of particle size distribution of the toner particles to 1.00 μm or less, the fiber cutting device may be controlled so as to make a conveying speed of the fiber-like toner and a rotary speed uniform. Also, when the classifying step is provided after the atomizing step, the standard deviation of particle size distribution of the toner particles can be set within the above range by controlling the classification accuracy.

Furthermore, an average circularity of the toner particles in the form of an elliptical body is preferably 0.92 or more and 0.95 or less. When the average circularity is less than 0.92, adhesion increases and faulty cleaning increases. In contrast, when the average circularity exceeds 0.95, the toner passes through a cleaning brush and the toner is not sufficiently removed from the image supporting material.

When the average circularity of toner particles is 0.92 or more and 0.95 or less, physical adhesion of toner particles can be suppressed. Consequently, faulty cleaning can be reduced. In order to set the average circularity of the toner particles within the above range, conditions of the spherodizing step such as amount of edges to be removed may be appropriately set in the spherodizing device.

The toner for a developer including the toner particles in the form of an elliptical body of the present embodiment and an external additive is preferably used in an image forming apparatus in which the apparatus includes an image supporting material and a brush cleaning method is used as a method for cleaning the surface of the image supporting material.

The toner for a developer including the toner particles in the form of an elliptical body can realize a reduction in faulty cleaning in an image forming apparatus in which the surface of the image supporting material is cleaned by the brush cleaning method. The brush used in the brush cleaning method is, for example, a fur brush. Also, the image supporting material is, for example, a photoconductor drum or an intermediate transfer material. The intermediate transfer material is, for example, an intermediate transfer belt. For example, in the image forming apparatus employing the brush cleaning method of removing a toner from the surface of the intermediate transfer belt using a fur brush, the toner for a developer including the toner particles in the form of an elliptical body of present embodiment is preferably used.

The toner for a developer according to the present embodiment includes the cylindrical toner particles prepared as described above, and an external additive. Also, the toner for a developer according to the another embodiment includes the toner particles in the form of an elliptical body formed by subjecting the cylindrical toner particles to a spheroidization treatment, and an external additive. The external additive in these embodiments will now be described.

The present inventors have studied and found that the amount of toner for a developer to be consumed in one operation of forming an image is limited and almost all of the toner in developing means is left in the developing means without being consumed and therefore, as formation of an image is repeated, the amount of the toner left in the developing means for a long period without being consumed tends to increase. When a friction force due to a regulating blade is repeatedly applied to the toner retained for a long period in the developing means, the external additive is embedded in toner particles or falls from toner particles and is lost. As a result, although various functions of the external additives tend to be lost, there arises a problem that it becomes impossible to obtain a stable and good image as the proportion of the toner left in the developing means increases by repeatedly forming an image.

It is considered that embedding or falling of the external additive is caused by the fact that conventional toner particles are mainly produced by a so-called grinding method. According to the grinding method, a binder resin, a colorant, and a wax serving as an anti-offset agent are melted with heating, followed by kneading, cooling, grinding and optional classification to produce toner particles.

The surface of toner particles produced by the grinding method corresponds to a fracture surface of a kneaded mixture of the respective toner components, and breakage of the kneaded mixture usually occurs along an interface between a binder resin and a low molecular weight component such as wax dispersed at random in the binder resin. Therefore, toner particles often have an uneven surface. Therefore, a friction force due to the regulating blade tends to be focused into specific toner particles in which the external additive adheres to a protrusion of the surface and the vicinity thereof. As a result, the external additive, to which a friction force is intensively applied, may be embedded in toner particles or fallen from toner particles.

As is apparent from the mechanism of the breakage above, a low molecular weight component such as wax is often exposed on the surface of toner particles, and the external additive adhered to the surface area where the low molecular weight component is exposed is likely to be embedded in toner particles when a friction force is applied, as compared with the external additive adhered to the surface area where the binder resin is exposed. The problem such as embedding tends to occur frequently as the particle size of the external additive decreases so as to improve the image quality of the formed image. That is, an external additive having a smaller particle size tends to be completely embedded in toner particles even when a friction force is applied fewer times, and thus functions of the external additive are lost.

The external additive used in the present embodiment for solving the above problems preferably contains silica having a primary particle size of 10 to 25 nm and a charge amount of 400 to 600 μC/g.

As described above, the toner particles in the present embodiment are produced by drawing the toner composition in a molten state into a cylindrical fiber and cutting the cylindrical fiber, and the surface exhibits a smooth cylindrical or elliptical body and has less unevenness as compared with those produced by a conventional grinding method. Therefore, a friction force due to a regulating blade can be uniformly applied by a number of external additives adhered onto the surface of the toner particles. Furthermore, in the cylindrical toner particles, a low molecular weight component such as wax is exposed only on a cut surface of the cylinder and the exposed area is remarkably smaller as compared with those produced by a conventional grinding method. Therefore, as compared with toner particles produced by the grinding method, embedding of the external additive into the toner particles and falling from the toner particles caused by a friction force due to a regulating blade can be remarkably reduced.

As a result, even when very fine silica having a primary particle size of 10 to 25 nm is externally added to the toner particles in the present embodiment, embedding of the silica into the toner particles caused by a friction force due to a regulating blade can be suppressed. Therefore, it is possible to maintain the function of improving fluidity of the toner due to the silica for a long period. Since the toner particles themselves are in the form of a cylindrical or elliptical body and easily flow as compared with those produced by the grinding method, fluidity of the toner for a developer can be improved. Therefore, the image quality of the formed image can be improved by forming more uniform thin layers on the surface of the developer supporting material, and also such an effect can be maintained for a long period.

When the primary particle size of silica exceeds 25 nm, since fluidity of the toner may be deteriorated when an image is formed under high temperature and high humidity conditions, it is impossible to obtain the effect of improving the image quality of the formed image by making uniform thin layers of the toner formed on the surface of the developer supporting material, and thus unevenness in density of the formed image may arise.

In contrast, when the primary particle size is less than 10 nm, even when used in combination with the cylindrical toner particles, silica is embedded in the toner particles within a very short period when a friction force is applied by a regulating blade. Therefore, it is impossible to obtain the effect of continuously forming a stable and good image without lowering image quality when used repeatedly to form an image for a long period. Since silica has a too small particle size, it is difficult to sufficiently obtain the effect of increasing the amount of the non-magnetic one-component toner, which is allowed to fly from the thin layers to the image supporting material upon development, by improving chargeability of the non-magnetic one-component toner, thereby improving the image density of the formed image and suppressing the occurrence of fog and toner scatter. Further, since silica has a too small particle size, silica is not removed by a cleaning blade for removing the toner left on the surface of the image supporting material after forming an image, and silica passes through the space between the cleaning blade and the image supporting material, and thus silica is left on the surface of the image supporting material and so-called dashmark defects may arise in the formed image.

The primary particle size of silica in the present embodiment is determined by the following procedure. Namely, an image at 200,000 times magnification of silica particles was taken under a transmission electron microscope and some particles were sampled at random from the image and then the diameter of silica particles was measured. The primary particle size is represented by an arithmetic mean value calculated from the measured value.

In the present embodiment, a charge amount of silica as the external additive is preferably from 400 to 600 μC/g. When the charge amount is 400 μC/g or more, it is possible to increase the amount of the toner, which is allowed to fly from the thin layers to the image supporting material upon development, by improving chargeability of the toner for a developer, and thus the image density of the formed image is improved and the occurrence of fog can be suppressed. When the charge amount of silica is 600 μC/g or less, it is possible to prevent electrical fixation of silica fallen from the surface of toner particles onto the surface of an image supporting material. Therefore, it is possible to suppress formation of so-called dashmark on the formed image caused by fallen silica fixed electrically on the surface of the image supporting material.

The charge amount of silica in the present embodiment can be determined by a so-called blow off method in which silica charged by mixing with a carrier is forcibly separated from the carrier by blowing air and a charge amount is measured.

For example, 100 g of a carrier having a weight average particle size of 35 μm obtained by coating the surface of a Mn/Mg ferrite core with a silicone resin and 0.4 g of silica as a measuring sample were placed in a polypropylene bottle under a normal temperature and a normal humidity environment and then mixed in a state of closing the bottle using a ball mill for 3 minutes. Using a blow-off charge amount measuring device TB-200 manufactured by KYOCERA Chemical Corporation, a change amount of silica was measured under the conditions of a blow pressure of 0.6 kgf and a blow time of 180 seconds.

In order to adjust the charge amount of silica within a range from 400 to 600 μC/g, the primary particle size of silica may be adjusted, or the kind and amount of a surface treating agent to be added to adjust chargeability or hydrophobicity of silica may be adjusted. Examples of the surface treating agent used to adjust chargeability of silica include a silane coupling agent such as aminosilane. Also, examples of the surface treating agent used to adjust hydrophobicity of silica include silicone oil. As the amount of these surface treating agent increases and the primary particle size of silica increases, the charge amount of silica can be increased.

In the present embodiment, when using silica having the above primary particle size and charge amount as the external additive, as shown in FIG. 6, the cylindrical toner particles preferably have a ratio a/b of a length a in an axis direction of a cylinder to a length b in a diameter direction of 2 or less. When the ratio a/b exceeds 2, toner particles show a large contact area between the developer supporting material and the surface and thus adhesion to the developer supporting material tends to increase. Therefore, as described above, even when the charge amount of silica is 400 μC/g or more, it is impossible to increase the amount of the toner, which is allowed to fly from the thin layers to the image supporting material upon development, and thus a decrease in the image density of the formed image, unevenness of the density and fog in the margin portion may occur, especially when an image is continuously formed. Also, toner particles having a ratio a/b of more than 2 exhibits large adhesion to the surface of the image supporting material, and thus toner particles are fixed to the surface of the image supporting material to cause dashmark.

The ratio a/b can include a minimum value in the toner particles which can be produced by the above melt blown method. For example, as described previously, when the toner particles are continuously produced by cutting the fiber-like toner composition using a fiber cutting device, a minimum value of the ratio a/b in the toner particles is preferably 1. The length a in an axis direction of the cylinder and the length b in a diameter direction of the toner particle can be respectively expressed by an average value calculated from the measured values of length a and b in 100 toner particles selected at random from image at 2,000 times magnification of the toner particles taken under a scanning electron microscope (JSM-880 manufactured by JEOL Ltd.).

Considering that an image having a high image quality is formed, a center particle size on volume basis of the toner particles is preferably from 3 to 10 μm, and particularly preferably from 4 to 7 μm. The center particle size on volume basis can be measured, for example, using Coulter Counter Multisizer 3 (manufactured by Beckman Coulter Co.). Specifically, a measuring sample is added in a solution prepared by adding a small amount of a surfactant in an electrolytic solution and the mixed solution is subjected to a dispersion treatment using an ultrasonic wave distributor, and then the solution containing the measuring sample dispersed therein is subjected to measurement using a measuring device to obtain a volume distribution of a particle size of the sample. Using ISOTONE II (manufactured by Beckman Coulter Co.) as the electrolytic solution, 100 μm aperture can be used.

The toner for a developer in the present embodiment can be produced by mixing the cylindrical or elliptical toner particles with the external additive in a predetermined ratio using a Henschel mixer (manufactured by Mitsui Mining Co., Ltd.). The amount of silica, as an external additive to be externally added, having a primary particle size of 10 to 25 nm and a charge amount of 400 to 600 μC/g is preferably from 0.1 to 5.0 parts by mass, and particularly preferably from 1.0 to 4.0 parts by mass, based on 100 parts by mass of the toner particles. When using in combination with external additives other than silica, the amount to be externally added is preferably from 0.5 to 10.0 parts by mass, and particularly preferably from 0.1 to 5.0 parts by mass, based on 100 parts by mass of the toner particles.

As the external additive, silica may be used alone, or silica may be used in combination with other conventionally known external additives. Examples of the other external additive include alumina, tin oxide, titanium oxide, strontium oxide and various resin powders, and these external additives may be used alone or in combination. As the other external additive, silica having a primary particle size and/or a charge amount, which are not within the above range, can be used in combination with silica of the present embodiment.

A two-component developer can be produced by mixing the toner for a developer of the present embodiment with a magnetic carrier. The external additive contained in the toner for a two-component developer will now be described. Duplication between the external additive contained in the above-described so-called non-magnetic one-component toner and the external additive contained in the toner for a two-component developer is omitted, and only a difference will be described.

In the present embodiment, the external additive contained in the toner for a two-component developer preferably contains silica having a primary particle size of 10 to 25 nm and a charge amount of 300 to 600 μC/g.

When the primary particle size of silica exceeds 25 nm, in case of forming an image under high temperature and high humidity conditions, fluidity of the toner for a two-component developer may be deteriorated. Therefore, when used in the hybrid developing method, it is impossible to obtain the effect of improving image quality of the formed image by making thin layers of the toner for a two-component developer formed on the surface of the developer supporting material uniform, and thus a decease in density of the formed image, unevenness of density and fog are likely to occur.

On the other hand, when the primary particle size is less than 10 nm, even when used in combination with the cylindrical toner particles, silica is embedded in the toner particles within a short period when a friction force is applied upon mixing with the carrier. Therefore, when used repeatedly to form an image for a long period, the effect of continuously forming a stable and good image without decreasing the image quality cannot be obtained. Also, since silica has a too small size, it is impossible in the hybrid developing method to sufficiently obtain the effect of increasing the amount of the toner for a two-component developer, which is allowed to fly from the thin layers to the image supporting material upon development, and it is impossible in the two-component developing method to sufficiently obtain the effect of preventing a decrease in an amount of the toner for a two-component developer to be migrated from the magnetic brush to the image supporting material, by improving chargeability of the toner for a two-component developer, thereby improving the image density of the formed image and suppressing the occurrence of fog or toner scatter.

When the primary particle size of silica is within a range from 10 to 25 nm, it is possible to improve the image quality of the formed image and image density and to suppress the occurrence of fog or toner scatter, and to maintain such an effect for a long period by improving fluidity and chargeability of the toner for a two-component developer.

When the charge amount of silica is less than 300 μC/g, it is impossible to obtain the effect of improving chargeability of the toner for a two-component developer, thereby increasing the amount of the toner for a two-component developer, which is allowed to fly from the thin layers to the image supporting material upon development, in the hybrid developing method. In the two-component developing method, it is impossible to obtain the effect of improving chargeability of the toner for a two-component developer, thereby preventing a decrease in an amount of the toner for a two-component developer to be migrated from the magnetic brush to the image supporting material. In both methods, it is difficult to obtain the effect of improving the image density of the formed image and suppressing the occurrence of fog or toner scatter. On the other hand, when the charge amount exceeds 600 μC/g, it is impossible to obtain the effect of improving chargeability of the toner for a two-component developer by suppressing carrier contamination as a result of adhesion of silica fallen from the surface of toner particles onto the surface of the carrier, thereby improving the image density of the formed image and suppressing the occurrence of fog or toner scatter.

When the charge amount of silica is within a range from 300 to 600 μC/g, it becomes possible to further improve the image density of the formed image while suppressing the occurrence of carrier contamination, fog, and toner scattering.

In the present embodiment, as shown in FIG. 6, in case of the cylindrical toner particles contained in the toner for a two-component developer, a ratio a/b of a length a in an axis direction of the cylinder to a length b in a diameter direction is preferably 2 or less. Since toner particles having a ratio a/b of more than 2 show a large contact area with the surface of the carrier or the surface of the developer supporting material, adhesion with these members tends to increase. Therefore, as described above, even when the charge amount of silica is 300 μC/g or more, it is impossible to increase the amount of the toner for a two-component developer, which is allowed to fly from the thin layers to the image supporting material upon development, in the hybrid developing method. In the two-component developing method, the amount of toner for a two-component developer, which is migrated from the magnetic brush to the image supporting material, decreases. Thus, when an image is continuously formed in both methods, there may arise a decrease in the image density of the formed image, the occurrence of density unevenness and the occurrence of fog in the margin portion.

In the present embodiment, the toner for a two-component developer can be produced by mixing the cylindrical or elliptical toner particles with then external additive in a predetermined ratio in a Henschel mixer (manufactured by Mitsui Mining Co., Ltd.). The amount of silica having a primary particle size of 10 to 25 nm and a charge amount of 300 to 600 μC/g to be externally added as the external additive is preferably from 0.1 to 5.0 parts by mass, and particularly preferably from 1.0 to 4.0 parts by mass, based on 100 parts by mass of the toner particles. When using an external additive other than silica, the amount is preferably from 0.5 to 10.0 parts by mass, and particularly preferably from 0.1 to 5.0 parts by mass, based on 100 parts by mass of the toner particles

The toner for a developer of the present embodiment is mixed with a carrier to give a two-component developer.

As the carrier, it is possible to use conventionally known carriers having various constitutions for a two-component developer. It is particularly preferred to use a so-called resin coated carrier obtained by coating the surface of a magnetic core with a coat layer of a resin. Specific examples of the core constituting the resin coated carrier include particles made of metals and alloys, such as iron, oxidized iron, reduced iron, magnetite, copper, silicon steel, ferrite, nickel, cobalt, iron-nickel alloy and iron-cobalt alloy; particles made of alloys of the above-mentioned metals with manganese, zinc and aluminum; particles made of ceramics such as titanium oxide, aluminum oxide, copper oxide, magnesium oxide, lead oxide, zirconium hydroxide, silicon carbide, magnesium titanate, barium titanate, lithium titanate, lead titanate, lead zirconate and lithium niobate; particles of substances having a high dielectric constant such as ammonium dihydrogen phosphate, potassium dihydrogen phosphate and rochelle salt; and resin carriers obtained by dispersing fine particles made of the above-mentioned materials in resin particles, and these particles may be used alone or in combination.

Examples of the resin for forming the resin coat layer include a (meth) acrylic polymer, a styrene-based polymer, a styrene-(meth)acrylic copolymer, an olefinic polymer (polyethylene, chlorinated polyethylene, polypropylene, etc.), polyvinyl chloride, polyvinyl acetate, polycarbonate, a cellulose resin, a polyester resin, an unsaturated polyester resin, a polyamide resin, a polyurethane resin, an epoxy resin, a silicone resin, a fluororesin (polytetrafluoroethylene, polychlorotrifluoroethylene, polyvinylidene fluoride, etc.), a phenol resin, a xylene resin, a diallyl phthalate resin, a polyacetal resin and an amino resin, and these resins may be used alone or in combination.

The weight average particle size of the carrier is preferably from 10 to 200 μm, and particularly preferably from 30 to 150 μm. The resin coat layer may optionally contain additives such as silica, alumina, carbon black, a fatty acid metal salt, a silane coupling agent and a titanate coupling agent, thereby adjusting the characteristics thereof. The thickness of the coat layer may be the same as usual, and is preferably from 0.01 to 10% by mass, and particularly preferably from 0.05 to 5% by mass, in terms of the amount of coating to the core.

The two-component developer can be produced by mixing the two-component toner for a developer of the present embodiment with the carrier in a predetermined mixing ratio. An image can be formed on a material to be printed such as paper by carrying out the above-described two-component developing method or hybrid developing method, using the two-component developer as a start developer and the same two-component toner for developer as a replenishing toner in an image forming apparatus such as a laser printer, an electrostatic copying machine, a plain paper facsimile device, or a composite machine thereof.

An image forming apparatus equipped with a developing apparatus for supplying the developer containing the toner for a developer of the present embodiment to an image supporting material so as to visualize an electrostatic latent image of the image supporting material will now be described.

The image forming apparatus according to another embodiment of the present invention preferably includes an image supporting material on which an electrostatic latent image is formed; a developing apparatus for supplying the above-described developer containing the toner for a developer to the image supporting material so as to visualize the electrostatic latent image of the image supporting material; an intermediate transfer belt onto which the toner image visualized on the image supporting material is temporarily held, the thickness of which is set to 300 μm or less; and a transfer device for transferring the toner image transferred onto the intermediate transfer belt onto a transfer material.

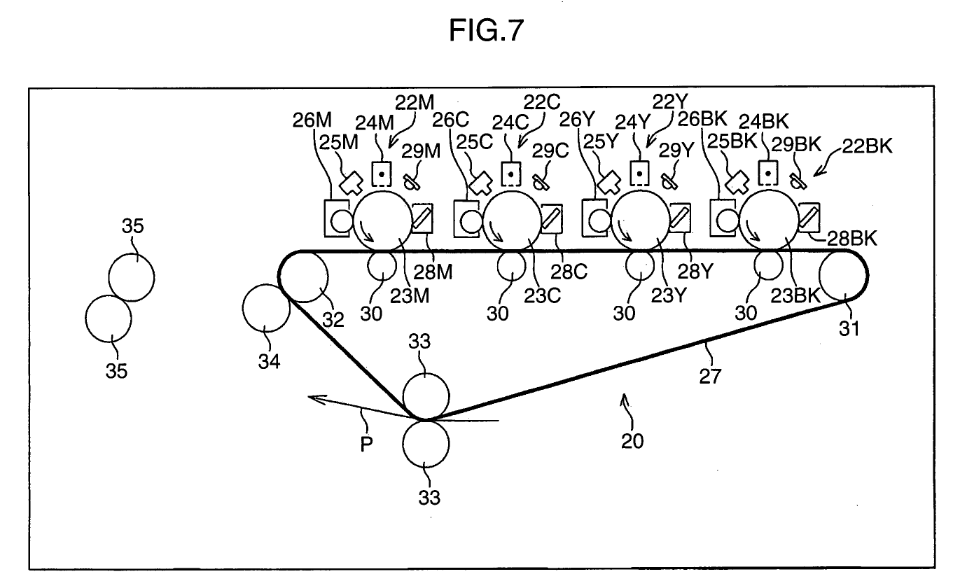

The present embodiment will now be described in detail with reference to the accompanying drawings. FIG. 7 is a schematic view showing a main constitution of an image forming apparatus according to one embodiment of the present invention.

The image forming apparatus is, for example, a tandem type color image forming apparatus and is equipped with an image forming mechanism 20 for forming a color image. In the image forming mechanism 20, an image forming unit 22M for magenta (M), an image forming unit 22C for cyan (C), an image forming unit 22Y for yellow (Y) and an image forming unit 22BK for black (BK) are sequentially arranged from left to right in FIG. 6. The respective image forming units 22M, 22C, 22Y and 22BK are equipped with cylindrical image supporting materials 23M, 23C, 23Y and 23BK; chargers 24M, 24C, 24Y and 24BK for charging the surfaces of image supporting materials 23M to 23BK; exposure devices 25M, 25C, 25Y and 25BK for exposing the surfaces of the image supporting materials 23M to 23BK charged by the chargers 24M to 24BK corresponding to the formed images; cylindrical developer supporting materials 26M, 26C, 26Y and 26BK for developing electrostatic latent images formed by exposure by supplying developers of each color (magenta, cyan, yellow and black) to the surfaces of the image supporting materials 23M to 23BK; cleaning devices 28M, 28C, 28Y and 28BK for removing the developer left on the surfaces of the image supporting materials 23M to 23BK after transferring the toner images onto an intermediate transfer belt 27; and destaticizing devices 29M, 29C, 29Y and 29BK for destaticizing the surfaces of the image supporting materials 23M to 23BK after transferring the toner images onto the intermediate transfer belt 27. The chargers 24M to 24BK, the exposure devices 25M to 25BK, the developing apparatuses 26M to 26BK, the transfer devices 27M to 27BK, the cleaning devices 28M to 28BK and destaticizing devices 29M to 29BK are sequentially arranged around the image supporting materials 23M to 23BK along a rotation direction of the image supporting materials 23M to 23BK.

The toner images of each color developed on the surfaces of the image supporting materials 23M to 23BK are transferred onto the endless intermediate transfer belt 27 by a primary transfer roller 30 provided corresponding to the image supporting materials 23M to 23BK and are temporarily held on the intermediate transfer belt 27. This intermediate transfer belt 27 is rotated in a state where a predetermined tension is applied by an action of a drive roller 31 and a tension roller 32. On the intermediate transfer belt 27, the toner images of each color are laid one upon another to form a full color toner image. By a secondary transfer roller 33, the full color toner image is transferred onto a paper P as a transfer material. Also, a cleaning fur brush 34 is provided corresponding to the tension roller 32 and the intermediate transfer belt 27 after transferring the toner image is cleaned by the cleaning fur brush 34. The paper P, onto which the full color toner image is transferred, is heated and pressed by a fixing device 35, thereby fixing the full color toner image on the paper P.

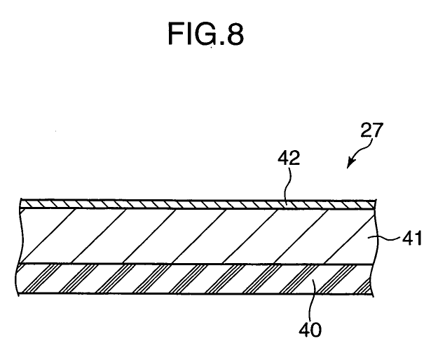

FIG. 8 is a sectional view showing the intermediate transfer belt 27. The intermediate transfer belt 27 is composed of a resin layer 40, an elastic layer 41 and the surface layer 42. On the resin layer 40, the elastic layer 41 is disposed, and the surface layer 42 is disposed on the elastic layer 41. The resin layer 40 is used for imparting strength to the intermediate transfer belt 27 and a resin such as polyvinylidene fluoride (PVDF) or polyimide can be used as the material. The thickness of the resin layer 40 is set to about 100 μm.

As the material of the elastic layer 41, for example, a CR rubber, a nitrile rubber (NBR) and a silicone rubber are used. The thickness of the elastic layer 41 is preferably set to 200 μm or less. By setting the thickness of the elastic layer 41 to 200 μm or less, the occurrence of distortion or color shift to the transfer image can be suppressed. When the thickness of the elastic layer 41 is more than 200 μm, distortion or color shift may occur in the transfer image.

The thickness of the elastic layer 41 can be set to 0 μm, namely, the elastic layer 41 can be omitted from the intermediate transfer belt 27. The surface layer 42 is a layer in contact with the image supporting materials 22M to 22BK or the paper P. For example, a layer made of a fluorine-based resin such as Teflon® can be used. The thickness of the surface layer 42 is set within a range from 2 to 3 μm.

The entire thickness of the intermediate transfer belt 27 is preferably 300 μm or less. By setting the thickness of the intermediate transfer belt 27 to 300 μm or less, the occurrence of distortion or color shift to the transfer image can be suppressed. When the thickness of intermediate transfer belt 27 is more than 300 μm, distortion or color shift may occur in the transfer image. Also, the entire thickness of the intermediate transfer belt 27 is preferably 80 μm or more. When the thickness of the intermediate transfer belt 27 is less than 80 μm, the strength of the intermediate transfer belt 27 is too low and it becomes difficult to stretch at a predetermined tension.

In the image forming apparatus, the developer used in the developing apparatuses 26M to 26BK is a non-magnetic one-component developer (non-magnetic one-component toner) which does not contain a carrier and contains a non-magnetic toner. The toner constituting the developer contains the cylindrical toner particles produced by the melt blown method.

After adding the external additive to the cylindrical toner particles, these components are mixed in a Henschel mixer (manufactured by Mitsui Mining Co., Ltd.) to obtain the non-magnetic one-component toner, that is, the developer. The external additive is used for improving fluidity of the toner and has a particle size of several tens to several hundreds of nanometers. In the cylindrical toner particles, the cylindrical cross-sectional diameter is set within a range from 4 to 9 μm and the cylindrical length is set within a range from 4 μm to 13 μm.

The developer used in developing apparatuses 26M to 26BK may be a one-component developer (one-component toner) containing no carrier when the toner contains the cylindrical toner particles described above, or may be a two-component developer (two-component toner) which contains the toner and the carrier. When the developer is a one-component developer (one-component toner), it may be a non-magnetic one-component developer (non-magnetic one-component toner) in which the toner is non-magnetic, or a magnetic one-component developer (magnetic one-component toner) in which the toner is magnetic.

In any type of the developer, the toner constituting the developer contains the cylindrical toner particles of the present embodiment.

As described above, a ground toner produced by a grinding method has a comparatively uneven surface. Therefore, the ground toner on the intermediate transfer belt has a comparatively large contact area with the intermediate transfer belt. Therefore, it is impossible to suppress the occurrence of a void phenomenon. Since the ground toner is produced by grinding, when a large amount of a releasant (wax) inside is exposed, the developer adheres onto the surface of the intermediate transfer belt due to the releasant and thus the occurrence of a void is accelerated.

Also, a polymer toner produced by a suspension polymerization method has a very high circularity (around 1). Since the circularity is too high, although the contact area with the intermediate transfer belt decreases and adhesion with the surface of the belt is reduced, cleaning properties is deteriorated, and thus defects such as filming occur in the image supporting material. When the thickness of the intermediate transfer belt is more than 300 μm, distortion or color shift occurs in the transfer image.

In contrast, in the case of the cylindrical toner particles of the present embodiment, adhesion between the toner particles and the surface layer 40 of the intermediate transfer belt 27 can be decreased. Therefore, the developer held on the intermediate transfer belt 27 is likely to separate from the intermediate transfer belt 27 upon secondary transfer and thus the developer satisfactorily removes toward a transfer material. Consequently, good transfer can be conducted and the occurrence of a void phenomenon can be suppressed. Therefore, even if the thickness of the intermediate transfer belt is set to 300 μm or less, the occurrence of a void phenomenon can be suppressed. Since the thickness of the intermediate transfer belt can be set to 300 μm or less, the occurrence of distortion or color shift to the transfer image can be suppressed. As a result, the occurrence of a void phenomenon can be suppressed and also the occurrence of distortion or color shift to the transfer image can be suppressed.

Therefore, even if the thickness of the elastic layer 41 is set to 200 μm or less and the thickness of the entire intermediate transfer belt 27 is set to 300 μm or less, the occurrence of a void phenomenon can be suppressed. Consequently, the occurrence of the void phenomenon can be suppressed and also the occurrence of distortion and color shift onto the transfer image can be suppressed.

When the thickness of the elastic layer is more than 200 μm, distortion or color shift may arise in the transfer image.

While the present invention has been described with reference to embodiments, it is to be understood that these embodiments are merely illustrative of the principles and applications of the present invention. It is therefore to be understood that numerous modifications may be made to the illustrative embodiments without departing from the spirit and scope of the present invention.

### EXAMPLES

The present invention will now be described by way of examples, but the present invention is not limited to the following examples.

### Example 1

### Preparation of Magnetic Two-Component Developer

Using, as toner materials, 100 parts by weight of a binder resin composed of a styrene-acrylic resin, carnauba wax (manufactured by Toa Chemical Co., Ltd.) as a releasant, 3 parts by weight of a charge control agent (P-51: manufactured by Orient Chemical Industries, Ltd.) and 5 parts by weight of carbon black (MA-100: manufactured by Mitsubishi Chemical Corporation) as a colorant, cylindrical toner particles having a volume average particle size of 6.5 μm were produced by the melt blown method using apparatuses shown in FIG. 2 and FIG. 3. To the cylindrical toner particles, 1.8 parts by mass of hydrophobic silica (RA-200H: manufactured by Nippon Aerogyl Co., Ltd.) as an external additive and 1.0 parts by mass of titanium oxide (ST-100: manufactured by Titan Kogyo Co., Ltd.) having a particle size of 250 nm were added, followed by mixing with stirring in a Henschel mixer (manufactured by Mitsui Mining Co., Ltd.) at a rotary circumferential speed of 40 m/s for 5 minutes to obtain a toner. This toner was mixed with a silicone resin-coated Mn/Mg-based ferrite carrier (manufactured by Powdertech Co., Ltd.) having an average particle size of 35 μm in a mixing ratio of the toner to the magnetic carrier of 1:10, followed by mixing with stirring for 30 minutes using a rocking mixer to obtain a magnetic two-component developer.

### Example 1-1

As the above magnetic two-component developer, a developer containing a toner, in which the cylindrical toner particles have a value L/D of 1.5 obtained by dividing the cylindrical length L of the cylindrical toner particles by the cylindrical cross-sectional diameter D of the cylindrical toner particles, an average circularity of the cylindrical toner particles of 0.897 and a standard deviation of particle size distribution of the cylindrical toner particles of 1.167 μm, was used.

### Example 1-2

As the above magnetic two-component developer, a developer containing a toner, in which the cylindrical toner particles have a value L/D of 1.6 obtained by dividing the cylindrical length L of the cylindrical toner particles by the cylindrical cross-sectional diameter D of the cylindrical particles, an average circularity of the cylindrical toner particles of 0.909 and a standard deviation of particle size distribution of the cylindrical toner particles of 1.161 μm, was used.

### Example 1-3

As the above magnetic two-component developer, a developer containing a toner, in which the cylindrical toner particles have a value L/D of 1.2 obtained by dividing the cylindrical length L of the cylindrical toner particles by the cylindrical cross-sectional diameter D of the cylindrical toner particles, an average circularity of the cylindrical toner particles of 0.938 and a standard deviation of particle size distribution of the cylindrical toner particles 1.186 μm, was used.

### Example 1-4

As the above magnetic two-component developer, a developer containing a toner, in which the cylindrical toner particles have a value L/D of 1.5 obtained by dividing the cylindrical length L of the cylindrical toner particles by the cylindrical cross-sectional diameter D of the cylindrical toner particles, an average circularity of the cylindrical toner particles of 0.899 and a standard deviation of particle size distribution of the cylindrical toner particles of 1.205 μm, was used.

### Example 1-5

As the above magnetic two-component developer, a developer containing a toner, in which the cylindrical toner particles have a value L/D of 2.1 obtained by dividing the cylindrical length L of the cylindrical toner particles by the cylindrical cross-sectional diameter D of and the cylindrical toner particles, an average circularity of the cylindrical toner particles of 0.881 and a standard deviation of particle size distribution of the cylindrical toner particles of 1.189 μm, was used.

### Comparative Example 1-1

As the above magnetic two-component developer, a developer containing a toner, in which the cylindrical toner particles have a value L/D of 2.1 obtained by dividing a cylindrical length L of the cylindrical toner particles by the cylindrical cross-sectional diameter D of the cylindrical toner particles, an average circularity of the cylindrical toner particles of 0.887 and a standard deviation of particle size distribution of the cylindrical toner particles of 1.212 μm, was used.

### Comparative Example 1-2

Using, as toner materials, 100 parts by weight of a binder resin composed of a styrene-acrylic resin, a carnauba wax (manufactured by Toa Chemical Co., Ltd.) as a releasant, 3 parts by weight of a charge control agent (P-51: manufactured by Orient Chemical Industries, Ltd.) and 5 parts by weight of carbon black (MA-100: manufactured by Mitsubishi Chemical Corporation) as a colorant, toner particles having a volume average particle size of 6.5 μm were produced by a grinding method including a melt-kneading step, a coarse grinding step, a fine grinding step and a classifying step. To the ground toner particles, 1.8 parts by mass of a hydrophobic silica (RA-200H: manufactured by Nippon Aerogyl Co., Ltd.) as an external additive and 1.0 parts by mass of titanium oxide (ST-100: manufactured by Titan Kogyo Co., Ltd.) having a particle size of 250 nm were added, followed by mixing with stirring in a Henschel mixer (manufactured by Mitsui Mining Co., Ltd.) at a rotary circumferential speed of 40 m/s for 5 minutes to obtain a toner. This toner was mixed with a ferrite carrier (manufactured by Powdertech Co., Ltd.) in a mixing ratio of the toner to the magnetic carrier of 1:10, followed by mixing with stirring for 30 minutes using a rocking mixer to obtain a magnetic two-component developer.

A magnetic two-component developer, in which the toner particles have a value L/D of 1.0 obtained by dividing a major diameter (herein referred to as L) of the toner particles produced by the grinding method by a minor diameter (herein refereed to as D), an average circularity of the toner particles of 0.939 and a standard deviation of particle size distribution of the toner particles of 1.235 μm, was used.

### Comparative Example 1-3

As the magnetic two-component developer produced by using the same materials and method as in Comparative Example 1-2, a developer containing a toner, in which the toner particles have a value L/D of 1.0 obtained by dividing a major diameter of the toner particles by a minor diameter, an average circularity of the toner particles of 0.936 and a standard deviation of particle size distribution of the toner particles of 1.245 μm, was used.

### Comparative Example 1-4

As the magnetic two-component developer produced by using the same materials and method as in Comparative Example 1-2, a developer containing a toner, in which the toner particles have a value L/D of 1.0 obtained by dividing a major diameter of the toner particles by a minor diameter, an average circularity of the toner particles of 0.929 and a standard deviation of particle size distribution of the toner particles of 1.264 μm, was used.

### Comparative Example 1-5

As the above magnetic two-component developer, a developer containing a toner (produced by the above melt blown method), in which the cylindrical toner particles have a value L/D of 1.5 obtained by dividing the cylindrical length L of the cylindrical toner particles by the cylindrical cross-sectional diameter D, an average circularity of the cylindrical toner particles of 0.935 and a standard deviation of particle size distribution of the cylindrical toner particles of 1.270 μm, was used.

### (Measuring Method)

The standard deviation (SD value) of particle size distribution of the toner particles was measured using a Coulter Counter Multisizer 3 (manufactured by Beckman Coulter Co.). Specifically, 10 mg of a measuring sample was added in a solution prepared by adding a small amount of a surfactant in an electrolytic solution, followed by subjecting to a dispersion treatment using an ultrasonic wave distributor. The solution containing the measuring sample dispersed therein was measured by the measuring device to obtain volume distribution of the sample particle size. ISOTONE II (manufactured by Beckman Coulter Co.) was used as the electrolytic solution and a 100 μm aperture was used as the aperture.

L/D obtained by dividing the cylindrical length of the cylindrical toner particles by the cylindrical cross-sectional diameter was determined by the following procedure. Namely, an image at 2,000 times magnification of the cylindrical toner particles was taken under a scanning electron microscope. At this time, 100 cylindrical toner particles were sampled at random from the image and then the cylindrical length and the cylindrical cross-sectional diameter of the respective cylindrical toner particles were measured. Then, the averages of the cylindrical length Land of the cylindrical cross-sectional diameter D were determined. In the case where the cut surface does not intersect perpendicularly to the central axis of the cylindrical toner (in the case where the cut surface is inclined or curved), the axis length of the central axis is referred to as the cylindrical length L. With respect to Comparative Examples 1-2 to 1-4, the value L/D was determined by dividing a major diameter (referred to as L herein) of toner particles by a minor diameter (referred to as D herein) using a measuring method in conformity with the above method for measuring the cylindrical toner particles.

The average circularity was measured under an environment at 23° C. and 60% RH using a flow particle image analyzer (FPIA-2100 manufactured by Sysmex Corporation), and circularity (a) of the measured particles was determined by the following equation and, furthermore, the value obtained by dividing the sum total of circularities of the measured entire particles by the number of particles was referred to as the average circularity.

a=L₀/L

where L₀ denotes the peripheral length of a circle having the same projection area as that of the projection image of particles, and L denotes the peripheral length when the projection image of particles is subjected to image processing at a resolution of image processing of 512×512 (a picture element measuring 0.3 μm×0.3 μm)

### (Evaluation of Performances)

Using the magnetic two-component developers of Example 1-1 to 1-5 and Comparative Examples 1-1 to 1-5 among the above ten kinds of magnetic two-component developers, an image was formed by a copying machine employing a two-component developing method (copying machine obtained by modifying a laser printer “KM-5530” manufactured by KYOCERA MITA corporation), based on an original copy having an original copy density of 4%, under a normal temperature and a normal humidity environment at a temperature of 20° C. and a humidity of 60%, and then performances were evaluated by the following methods.

### (i) Tone

Tone was evaluated so as to confirm the effect of improving tone. The copied image was visually observed and tone was evaluated.

A: Excellent tone
B: Ordinary tone
C: Poor tone
D: Very poor tone

### (ii) Image Density

Image density was evaluated so as to confirm the effect of improving developability. Using a reflection densitometer (TC-6D manufactured by Tokyo Denshoku Co., Ltd.), the image density at three portions corresponding to a black solid portion of one copied image was measured and the average of the measured image densities was employed as the image density of the formed image. Evaluation was performed according to the following criteria. As the evaluation standard, the case where the image density is 1.30 or more was desired, and more preferably 1.40 or more.

The respective performances were evaluated after an image forming treatment in which the continuous printing of 10,000 sheets was carried out. As used herein, continuous printing means printing in which an image is continuously formed.

The evaluation results are shown in Table 1.

TABLE 1

| | SD | | average | | Image |
|---|---|---|---|---|---|
| | value | L/D | circularity | Tone | Density |
| Example 1-1 | 1.167 | 1.5 | 0.897 | A | 1.45 |
| Example 1-2 | 1.161 | 1.6 | 0.909 | A | 1.48 |
| Example 1-3 | 1.186 | 1.2 | 0.938 | B | 1.42 |
| Example 1-4 | 1.205 | 1.5 | 0.899 | B | 1.41 |
| Example 1-5 | 1.189 | 2.1 | 0.881 | B | 1.40 |
| Comparative | 1.212 | 2.1 | 0.887 | C | 1.30 |
| Example 1-1 | | | | | |
| Comparative | 1.235 | 1.0 | 0.939 | C | 1.29 |
| Example 1-2 | | | | | |
| Comparative | 1.245 | 1.0 | 0.936 | C | 1.31 |
| Example 1-3 | | | | | |
| Comparative | 1.264 | 1.0 | 0.929 | D | 1.25 |
| Example 1-4 | | | | | |
| Comparative | 1.270 | 1.5 | 0.935 | D | 1.23 |
| Example 1-5 | | | | | |

As is apparent from the test results shown in Table 1, the toners of Examples 1-1, 1-2, 1-3 and 1-5 in which the standard deviation (SD value) of particle size distribution of the cylindrical toner particles obtained by the melt blown method is 1.20 μm or less are excellent in tone and developability as compared with those of Comparative Example 1-1 and Comparative Example 1-5 in which the standard deviation of the particle size distribution of the cylindrical toner particles is not within the above range.

Also, the toners of Examples 1-1 to 1-4 in which the value L/D obtained by dividing the cylindrical length of the cylindrical toner particles by the cylindrical cross-sectional diameter is 1.0 or more and 2.0 or less are excellent in tone and developability as compared with those of Comparative Example 1-1 and Comparative Example 1-5 in which the value of L/D obtained by dividing the cylindrical length of cylindrical toner particles by the cylindrical cross-sectional diameter is not within the above range.

Furthermore, the toners of Examples 1-1, 1-2 and 1-4 in which the average circularity of the cylindrical toner particles is 0.890 or more and 0.920 or less are excellent in tone and developability as compared with the cylindrical toner particles of Comparative Example 1-1 and Comparative Example 1-5 in which the average circularity of the cylindrical toner particles is not within the above range.

The toners including the cylindrical toner particles produced by the melt blown method of Examples 1-1 to 1-5 are excellent in tone and developability as compared with the toners including the toner particles produced by the grinding method of Comparative Examples 1-2 to 1-4.

Furthermore, the toners of Examples 1-1 and 1-2, in which the standard deviation of particle size distribution of the cylindrical toner particles (SD value) is 1.20 μm or less, the value L/D obtained by dividing the cylindrical length of the cylindrical toner particles by the cylindrical cross-sectional diameter is 1.0 or more and 2.0 or less, and also the average circularity of the cylindrical toner particles is 0.890 or more and 0.920 or less, are more excellent in tone and developability as compared with the toner of Example 1-3 in which the average circularity is not within the above range, the toner of Example 1-4 in which the standard deviation of particle size distribution is not within the above range, and the toner of Example 1-5 in which the value L/D obtained by dividing the cylindrical length of cylindrical toner particles by the cylindrical cross-sectional diameter is not within the above range.

### Example 2

### Example 2-1

### Production of Toner Particles

As toner components, a styrene-acrylic resin having a weight average molecular weight Mw of 5,000 as a binder resin (a), a styrene-acrylic resin having a weight average molecular weight Mw of 350,000 as a binder resin (b), carbon black MA100 (manufactured by Mitsubishi Chemical Corporation) as a colorant, a wax (FT100 manufactured by Nippon Seiro Co., Ltd.) and a positive charge control agent (N-01 manufactured by Orient Chemical Industries, Ltd.) were supplied to a premixing device 7 (FIG. 2) among the production processes described above in each proportion shown in the following Table 2-1.

TABLE 2-1

| | Parts by |
|---|---|
| Component | mass |
| binder resin (a) | 70 |
| binder resin (b) | 30 |
| Colorant | 5 |
| Wax | 5 |
| positive charge control | 3 |
| agent | |

In accordance with the production processes of FIG. 2 and FIG. 3, as described above, the toner components were subjected to various steps such as premixing using a premixing device 7, kneading using a single screw extruder 1, adjustment of pressure and extrusion amount using a gear pump 4, additional kneading in a static mixer 2 and a flow passage structure 3, extrusion through nozzles 6, drawing using a hot blast and quenching using a cold blast to produce multiple fiber-like materials 12 in the form of a cylindrical fiber. The multiple fiber-like materials 12 were air-cooled while conveying on a belt conveyor 11 and then cut by a fiber cutting device 8 to continuously produce cylindrical toner particles in which a length a in an axis direction of a cylinder is 6.5 μm, a length b in a diameter direction is 9.7 μm and a center particle size on volume basis is 8.0 μm. The length a in an axis direction of the cylinder corresponding to a cut length of the fiber-like material 12 was adjusted by the ratio of the conveying speed of the fiber-like material 12 to the rotary speed of the rotary knife 10.

As described above, the length a in an axis direction of a cylinder and the length b in a diameter direction (see FIG. 6) of toner particles were respectively expressed by the average calculated from measured values of lengths a, b in 100 toner particles selected at random from images at 2,000 times magnification of toner particles taken using a scanning electron microscope (JSM-880 manufactured by JEOL Ltd.). Also, the center particle size on volume basis of the toner particles was expressed by the value calculated from measured values of particle size distribution measured using the above-described particle size distribution measuring device (Multisizer 3 manufactured by Beckman Coulter Inc.) under the conditions of an aperture size of 100 μm.

### (Preparation of Electrophotographic Toner)

100 parts by mass of the toner particles, 1.0 parts by mass of silica (RA-200H manufactured by Nippon Aerogyl Co., Ltd.) as an external additive and 0.8 parts by mass of titanium oxide (ST-100 manufactured by Titan Kogyo Co., Ltd.) were mixed using a Henschel mixer (manufactured by Mitsui Mining Co., Ltd.) to prepare an electrophotographic toner.

### Example 2-2

In the same manner as in Example 2-1, except that a styrene-acrylic resin having a weight average molecular weight Mw of 5,000 as a binder resin (a), a styrene-acrylic resin having a weight average molecular weight Mw of 350,000 as a binder resin (b), a styrene-acrylic resin having a weight average molecular weight Mw of 48,000 as a binder resin (c), carbon black (MA100 manufactured by Mitsubishi Chemical Corporation) as a colorant, wax (FT100 manufactured by Nippon Seiro Co., Ltd.) and a positive charge control agent (N-01 manufactured by Orient Chemical Industries, Ltd.) were used as toner components and the toner components were supplied to a premixing device 7 in the production process shown in FIG. 2 in each proportion shown in Table 2-2 below, toner particles were prepared and an electrophotographic toner was prepared.

TABLE 2-2

| | Parts by |
|---|---|
| Component | mass |
| binder resin (a) | 68 |
| binder resin (b) | 22 |
| binder resin (c) | 10 |
| Colorant | 5 |
| Wax | 5 |
| positive charge control | 3 |
| agent | |

### Comparative Example 2-1

In the same manner as in Example 2-1, except that a styrene-acrylic resin having a weight average molecular weight Mw of 5,000 as a binder resin (a), a styrene-acrylic resin having a weight average molecular weight Mw of 300,000 as a binder resin (d), carbon black (MA100 manufactured by Mitsubishi Chemical Corporation) as a colorant, wax (FT100 manufactured by Nippon Seiro Co., Ltd.) and a positive charge control agent (N-01 manufactured by Orient Chemical Industries, Ltd.) were used as toner components and the toner components were supplied to a premixing device 7 in the production process shown in FIG. 2 in each proportion shown in Table 2-3 below, toner particles were prepared and an electrophotographic toner was prepared.

TABLE 2-3

| | Parts by |
|---|---|
| Component | mass |
| binder resin (a) | 70 |
| binder resin (d) | 30 |
| Colorant | 5 |
| Wax | 5 |
| positive charge control | 3 |
| agent | |

### Comparative Example 2-2

Using the same components as those used in Example 2-1 in the same proportion, toner particles having a center particle size on volume basis of 8.0 μm were produced by a grinding method and an electrophotographic toner was prepared.

### (Calculation of Inclination Value Sυ)

1.8 g of each of the electrophotographic toners produced in the respective Examples and Comparative Examples was weighed, filled in a mold for compression molding, which has an inner diameter corresponding to an inner diameter of a cylinder for a flow tester (CFT-500D manufactured by Shimadzu Corporation), and then compression-molded under a pressure of 1,000 kg/cm² to obtain a tablet-shaped sample for measurement.

Then, the sample was encased in a cylinder of the flow tester and the temperature in the cylinder was gradually increased at a temperature raising rate of 4° C. per minute while applying a load of 30 kgf to the same in the cylinder in accordance with the measuring method described in Japanese Industrial Standard JIS K7210: 1999 “Test Method of Melt Mass Flow Rate (MFR) and Melt Volume Flow Rate (MVR) of Plastic-Thermoplastic Plastic”. In the case where the sample is melted and flows out of the cylinder through a die measuring 1 mm in diameter and 1 mm in length provided at the bottom of the cylinder, the change in the flow rate was measured. The change in the melt viscosity with an increase of the temperature was determined from the measured value and a graph of the relationship between the melt viscosity and the temperature characteristics was made.

From the graph of the relationship between the melt viscosity and the temperature characteristics, a melt viscosity υ₁ (Pa·S) at a temperature T₁ (° C.), which is the temperature at which the molten sample began to flow out through the die plus 5° C., and a melt viscosity υ₂ (Pa·S) at a temperature T₂ (° C.), which is the temperature at which the entire sample flowed out and flowing-out has been completed minus 5° C., were determined, and then an inclination value Sυ of melt viscosity-temperature characteristics was calculated from aforementioned equation (4).

### (Actual Machine Test)

Each of the electrophotographic toners prepared in the respective Examples and Comparative Examples was mixed in an amount of 7 parts by mass based on 100 parts by mass of a ferrite carrier (weight average particle size: 80 μm, silicone resin coat, manufactured by Powdertech Co., Ltd.) to prepare a two-component developer. Using the two-component developer as a start developer in a machine obtained by modifying a monochromic composite machine KM-5530 manufactured by KYOCERA MITA Corporation and using the same electrophotographic toner as that used in the two-component developer as a replenishing toner, an image was formed under a normal temperature and a normal humidity environment at a temperature of 20 to 23° C. and a relative humidity of 50 to 65% RH, and then the following evaluations were performed.

### (Measurement of Image Density and Fog Density)

Under a normal temperature and a normal humidity environment, images were continuously formed on 80,000 sheets of a standard pattern at a printing rate of 5%. Afterward, the image density of the solid portion after printing on 1st, 20,000th, 40,000th, 60,000th and 80,000th sheets was measured using a reflection densitometer (TC-6D manufactured by Tokyo Denshoku Co., Ltd.) and the resulting image density is referred to as an image density. The image density of the margin portion of the same formed image was measured using the reflection densitometer and the resulting image density is referred to as a fog density.

(Observation of Adhesion onto Drum)

Under a normal temperature and a normal humidity environment, images were continuously formed on 80,000 sheets of a standard pattern at a printing rate of 5%. Afterwards, with respect to the image formed after printing on 1st, 20,000th, 40,000th, 60,000th and 80,000th sheets, it was observed whether or not image defects involved in drum adhesion occurred.

The above results are shown in Table 2-4.

TABLE 2-4

| | | | Number of sheets printed | | | | |
|---|---|---|---|---|---|---|---|
| | Sν | Actual machine | | 20,000th | 40,000th | 60,000th | 80,000th |
| | (Pa · S/° C.) | Test | First sheet | sheet | sheet | sheet | sheet |
| Example 2-1 | 9.7 × 10³ | Image Density | 1.38 | 1.36 | 1.35 | 1.36 | 1.35 |
| | | Fog Density | 0.002 | 0.003 | 0.002 | 0.002 | 0.001 |
| | | Adhesion onto | Not Adhered | Not Adhered | Not Adhered | Not Adhered | Not Adhered |
| | | Drum | | | | | |
| Example 2-2 | 8.8 × 10³ | Image Density | 1.36 | 1.35 | 1.35 | 1.35 | 1.33 |
| | | Fog Density | 0.001 | 0.002 | 0.003 | 0.002 | 0.002 |
| | | Adhesion onto | Not Adhered | Not Adhered | Not Adhered | Not Adhered | Not Adhered |
| | | Drum | | | | | |
| Comparative | 1.2 × 10⁴ | Image Density | 1.36 | 1.34 | 1.35 | 1.34 | 1.34 |
| Example 2-1 | | Fog Density | 0.002 | 0.002 | 0.001 | 0.008 | 0.012 |
| | | Adhesion onto | Not Adhered | Not Adhered | Not Adhered | Adhered | Adhered |
| | | Drum | | | | | |
| Comparative | 1.0 × 10⁴ | Image Density | 1.37 | 1.33 | 1.32 | — | — |
| Example 2-2 | | Fog Density | 0.004 | 0.005 | 0.012 | — | — |
| | | Adhesion onto | Not Adhered | Adhered | Adhered | — | — |
| | | Drum | | | | | |

When using the electrophotographic toner of Comparative Example 2-2, in which toner particles produced by a grinding method are used, it was confirmed that drum adhesion was already occurred on the image after printing 20,000 sheets. After printing 40,000 sheets, the fog density increased and drum adhesion became severe, and thus image formation was abandoned. Although toner particles were produced using a melt blown method, when using the electrophotographic toner of Comparative Example 2-1 in which an inclination value Sυ of melt viscosity-temperature characteristics of the toner including the toner particles exceeds 1×10⁴ Pa·S/° C., it was confirmed that the fog density increased and drum adhesion occurred on the image after printing 60,000 and 80,000 sheets.

In contrast, when using the electrophotographic toners of Examples 2-1 and 2-2, in which toner particles are produced by the melt blown method and also an inclination value Sυ of melt viscosity-temperature characteristics of the toner including the toner particles is 1×10⁴ Pa·S/° C. or lower, it was confirmed that a satisfactory image could always be formed after printing 1 to 80,000 sheets without causing an increase in the fog density, drum adhesion and a decrease in the image density.

### Example 3

### Example 3-1

### Production of Toner Particles

A styrene-acrylic resin having a weight average molecular weight Mw of 5,000 as a binder resin (a), a styrene-acrylic resin having a weight average molecular weight Mw of 350,000 as a binder resin (b), carbon black (MA100 manufactured by Mitsubishi Chemical Corporation) as a colorant, a wax (MP-WAXL-994 manufactured by Chukyo Yushi Co., Ltd., melting point: 100° C.) and a positive charge control agent (N-O1 manufactured by Orient Chemical Industries, Ltd.) were used as toner components and the toner components were supplied to a premixing device 7 in the production process shown in FIG. 2 in each proportion shown in Table 3-1 below, toner particles were prepared and an electrophotographic toner was prepared.

TABLE 3-1

| Component | Parts by mass |
|---|---|
| binder resin (a) | 70 |
| binder resin (b) | 30 |
| colorant | 5 |
| wax | 5 |
| positive charge control agent | 3 |

In accordance with the production processes shown in FIG. 2 and FIG. 3, as described above, the toner components were subjected to various steps such as premixing using a premixing device 7, kneading using a single screw extruder 1, adjustment of pressure and an extrusion amount using a gear pump 4, additional kneading in a static mixer 2 and a flow passage structure 3, extrusion through nozzles 6, drawing using hot air and quenching using cold air to produce multiple fiber-like materials 12 in the form of a cylindrical fiber. The multiple fiber-like materials 12 are air-cooled while conveying on a belt conveyor 11 and then cut by a fiber cutting device 8 to continuously produce cylindrical toner particles in which a length a in an axis direction of a cylinder is 6.5 μm, a length b in a diameter direction is 9.7 μm and a center particle size on volume basis is 8.0 μm. The length a in an axis direction of a cylinder corresponding to a cut length of the fiber-like material 1 was adjusted by the ratio of the conveying speed of the fiber-like material 12 to the rotary speed of the rotary knife 10.

As described above, the length a in an axis direction of a cylinder and the length b in a diameter direction (see FIG. 6) of the toner particles were respectively expressed by an average calculated from measured values of lengths a, b in 100 toner particles selected at random from images at 2,000 times magnification of toner particles taken using a scanning electron microscope (JSM-880 manufactured by JEOL Ltd.). Also, the center particle size on volume basis of the toner particles was expressed by a value calculated from the measured values of particle size distribution measured using the above-described particle size distribution measuring device (Multisizer 3 manufactured by Beckman Coulter Inc.) under the conditions of an aperture size of 100 μm.

### (Preparation of Electrophotographic Toner)

100 parts by mass of the toner particles, 1.0 parts by mass of silica (RA-200H manufactured by Nippon Aerogyl Co., Ltd.) as an external additive and 0.8 parts by mass of titanium oxide (ST-100 by manufactured by Titan Kogyo Co., Ltd.) were mixed in a Henschel mixer (manufactured by Mitsui Mining Co., Ltd.) to prepare an electrophotographic toner.

### Example 3-2

In the same manner as in Example 3-1, except that a styrene-acrylic resin having weight average molecular weight Mw of 5,000 as a binder resin (a), a styrene-acrylic resin having a weight average molecular weight Mw of 350,000 as a binder resin (b), a styrene-acrylic resin having a weight average molecular weight Mw of 48,000 as a binder resin (c), carbon black (MA100 manufactured by Mitsubishi Chemical Corporation) as a colorant, a wax (MP-WAXL-994 manufactured by Chukyo Yushi Co., Ltd., melting point: 100° C.) and a positive charge control agent (N-01 manufactured by Orient Chemical Industries, Ltd.) were used as toner components and the toner components were supplied to a premixing device 7 in the production process shown in FIG. 2 in each proportion shown in Table 3-2 below, toner particles were prepared and an electrophotographic toner was prepared.

TABLE 3-2

| Component | Parts by mass |
|---|---|
| binder resin (a) | 68 |
| binder resin (b) | 22 |
| binder resin (c) | 10 |
| colorant | 5 |
| wax | 5 |
| positive charge control agent | 3 |

### Example 3-3

In the same manner as in Example 3-1, except that the same amount of Ceridust®2051 (melting point: 81° C.) manufactured by Clariant Corp. was used as a wax, toner particles were prepared and an electrophotographic toner was prepared.

### Comparative Example 3-1

In the same manner as in Example 3-1, except that a styrene-acrylic resin having a weight average molecular weight Mw of 5,000 as a binder resin (a), a styrene-acrylic resin having a weight average molecular weight Mw of 300,000 as a binder resin (d), carbon black (manufactured by Mitsubishi Chemical Corporation) as a colorant, wax (MP-WAXL-994 manufactured by Chukyo Yushi Co., Ltd., melting point: 100° C.) and a positive charge control agent (N-01 manufactured by Orient Chemical Industries, Ltd.) were used as toner components and the toner components were supplied to a premixing device 7 in the production process shown in FIG. 2 in each proportion shown in Table 3-3 below, toner particles were prepared and an electrophotographic toner was prepared.

TABLE 3-3

| Component | Parts by mass |
|---|---|
| binder resin (a) | 70 |
| binder resin (d) | 30 |
| colorant | 5 |
| wax | 5 |
| positive charge control agent | 3 |

### Comparative Example 3-2

In the same manner as in Example 3-1, except that the same amount of FT100 (melting point: 103° C.) manufactured by Nippon Seiro Co., Ltd. was used as a wax, toner particles were prepared and an electrophotographic toner was prepared.

### (Calculation of Inclination Value Sυ)

1.8 g of each of the electrophotographic toners produced in the respective Examples and Comparative Examples was weighed, filled into a mold for compression molding, which has an inner diameter corresponding to that of a cylinder for a flow tester (CFT-500D manufactured by Shimadzu Corporation) and then compression-molded under a pressure of 1,000 kg/cm² to obtain a tablet-shaped measuring sample.

Then, the sample was encased in a cylinder of the flow tester and the temperature in the cylinder was gradually increased at a temperature raising rate of 4° C. per minute while applying a load of 30 kgf to the same in the cylinder in accordance with the measuring method described in Japanese Industrial Standard JIS K7210: 1999 “Test Method of Melt Mass Flow Rate (MFR) and Melt Volume Flow Rate (MVR) of Plastic-Thermoplastic Plastic”. In the case where the sample is melted and flows out of the cylinder through a die measuring 1 mm in diameter and 1 mm in length provided at the bottom of the cylinder, the change in the flow rate was measured. The change in melt viscosity with the increase of the temperature was determined from the measured value and a graph of the relationship between the melt viscosity and the temperature characteristics was made.

From the graph of the relationship between the melt viscosity and the temperature characteristics, a melt viscosity υ₁ (Pa·S) at a temperature T₁ (° C.), which is the temperature at which the molten sample began to flow out through the die plus 5° C., and a melt viscosity υ₂ (Pa·S) at a temperature T₂ (° C.), which is the temperature at which the entire sample flowed out and flowing-out has been completed minus 5° C., were determined, and then an inclination value Sυ of melt viscosity-temperature characteristics was calculated from the aforementioned equation (4).

### (Actual Machine Test)

Each of the electrophotographic toners prepared in the respective Examples and Comparative Examples was mixed in an amount of 7 parts by mass based on 100 parts by mass of a ferrite carrier (weight average particle size: 80 μm, silicone resin coat, manufactured by Powdertech Co., Ltd.) to prepare a two-component developer. The two-component developer was used as a start developer in a machine obtained by modifying a monochromic composite machine KM-5530 manufactured by KYOCERA MITA corporation and using the same electrophotographic toner as used in the two-component developer as a replenishing toner, an image was formed under a normal temperature and a normal pressure environment at a temperature of 20 to 23° C. and a relative humidity of 50 to 65% RH, and then the following evaluations were performed.

### (Measurement of Image Density and Fog Density)

Under the above normal temperature and normal humidity environment, images were continuously formed on 80,000 sheets of a standard pattern at a printing rate of 5%. Afterwards, the image density of the solid portion after printing on 1st, 20,000th, 40,000th, 60,000th and 80,000th sheets was measured using a reflection densitometer (TC-6D manufactured by Tokyo Denshoku Co., Ltd.) and the resulting image density is referred to as an image density. The image density of the margin portion of the same formed image was measured using the reflection densitometer and the resulting image density is referred to as a fog density.

(Observation of Adhesion onto Drum)

Under a normal temperature and a normal humidity environment, images were continuously formed on 80,000 sheets of a standard pattern at a printing rate of 5%. Afterwards, with respect to the image formed after printing on 1st, 20,000th, 40,000th, 60,000th and 80,000th sheets, it was observed whether or not image defects involved in drum adhesion occurred.

The above results are shown in Table 3-4.

TABLE 3-4

| | Sν | | Number of sheets printed | | | | |
|---|---|---|---|---|---|---|---|
| | (Pa · S/° C.) | Actual machine Test | First sheet | 20,000th sheet | 40,000th sheet | 60,000th sheet | 80,000th sheet |
| Example 3-1 | 9.8 × 10³ | Image Density | 1.36 | 1.34 | 1.34 | 1.36 | 1.35 |
| | | Fog Density | 0.001 | 0.002 | 0.001 | 0.002 | 0.001 |
| | | Adhesion onto Drum | Not Adhered | Not Adhered | Not Adhered | Not Adhered | Not Adhered |
| Example 3-2 | 8.9 × 10³ | Image Density | 1.35 | 1.35 | 1.33 | 1.34 | 1.35 |
| | | Fog Density | 0.002 | 0.003 | 0.002 | 0.003 | 0.002 |
| | | Adhesion onto Drum | Not Adhered | Not Adhered | Not Adhered | Not Adhered | Not Adhered |
| Example 3-3 | 9.8 × 10³ | Image Density | 1.36 | 1.34 | 1.33 | 1.32 | 1.32 |
| | | Fog Density | 0.003 | 0.004 | 0.003 | 0.004 | 0.005 |
| | | Adhesion onto Drum | Not Adhered | Not Adhered | Not Adhered | Not Adhered | Not Adhered |
| Comparative | 1.2 × 10⁴ | Image Density | 1.38 | 1.36 | 1.35 | 1.36 | 1.35 |
| Example 3-1 | | Fog Density | 0.002 | 0.003 | 0.002 | 0.007 | 0.011 |
| | | Adhesion onto Drum | Not Adhered | Not Adhered | Not Adhered | Adhered | Adhered |
| Comparative | 9.7 × 10³ | Image Density | 1.38 | 1.36 | 1.35 | 1.36 | 1.35 |
| Example 3-2 | | Fog Density | 0.002 | 0.003 | 0.002 | 0.002 | 0.001 |
| | | Adhesion onto Drum | Not Adhered | Not Adhered | Not Adhered | Not Adhered | Not Adhered |

Although toner particles were produced using a melt blown method, when using the electrophotographic toner of Comparative Example 3-1 in which an inclination value Sυ of melt viscosity-temperature characteristics of the toner including the toner particles exceeds 1×10⁴ Pa·S/° C., it was confirmed that the fog density increased and drum adhesion occurred on the image after printing 60,000 and 80,000 sheets, as shown in Table 3-4.

In contrast, when using the electrophotographic toners of Examples 3-1 to 3-3 and Comparative Example 3-2 in which the toner particles are produced by a melt blown method and also an inclination value Sυ of melt viscosity-temperature characteristics of the toner including the toner particles is 1×10⁴ Pa·S/° C. or lower, it was confirmed that satisfactory image can always be formed after printing 1 to 80,000 sheets without causing an increase in the fog density, drum adhesion and a decrease in the image density.

### (Evaluation of Fixing Properties)

Under the normal temperature and normal humidity environment, and a low temperature and a low humidity environment at a temperature of 10 to 15° C. and a relative humidity of 30 to 35% RH, images were continuously formed on 100 sheets of a solid pattern measuring 20 mm in length and 20 mm in width. Each of the formed images shown in Table 3-5 below was subjected to reciprocating friction five times using a weight (1,035 g, bottom area of 20 cm²) having a frictional surface coated completely with a gauze in a state where the frictional surface coated with the gauze and the solid pattern are laid one upon another. Then, the image density of the solid pattern before and after the friction was measured using a reflection densitometer (TC-6D manufactured by Tokyo Denshoku Co., Ltd.) and the retention (%) of the image density before and after the friction was determined by the following equation:

$$RETENTION OF IMAGE DENSITY ( \% ) = \frac{IMAGE DENSITY AFTER FRICTION}{IMAGE DENSITY BEFORE FRICTION} \times 100$$

Then, fixing properties were evaluated.

The results are shown in Table 3-5.

TABLE 3-5

| retention (%) of the image | | Example | Example | Example | Comparative | Comparative |
|---|---|---|---|---|---|---|
| density | | 3-1 | 3-2 | 3-3 | Example 3-1 | Example 3-2 |
| Under | First sheet | 98.5 | 99.1 | 99.7 | 97.9 | 97.1 |
| normal | Second sheet | 98.2 | 99.1 | 99.4 | 97.5 | 96.5 |
| temperature | Third sheet | 97.8 | 98.7 | 99.4 | 97.3 | 96.2 |
| and normal | Forth sheet | 97.8 | 98.5 | 99.2 | 97.0 | 95.8 |
| humidity | Fifth sheet | 97.6 | 98.0 | 98.9 | 97.2 | 96.0 |
| environment | 10th sheet | 96.8 | 98.2 | 98.7 | 96.7 | 95.1 |
| | 20th sheet | 96.2 | 97.9 | 98.4 | 96.1 | 94.6 |
| | 40th sheet | 96.1 | 97.8 | 98.6 | 95.2 | 93.7 |
| | 60th sheet | 97.0 | 98.0 | 99.0 | 96.7 | 94.3 |
| | 80th sheet | 97.4 | 97.7 | 98.9 | 97.1 | 93.8 |
| | 100th sheet | 97.1 | 97.9 | 99.2 | 96.9 | 92.9 |
| Under low | First sheet | 96.2 | 97.5 | 98.2 | 96.0 | 94.5 |
| temperature | Second sheet | 96.4 | 97.7 | 97.9 | 94.8 | 92.5 |
| and a low | Third sheet | 95.9 | 97.2 | 98.0 | 94.5 | 92.1 |
| humidity | Forth sheet | 95.1 | 96.8 | 97.7 | 93.1 | 91.6 |
| environment | Fifth sheet | 94.3 | 96.9 | 97.4 | 92.6 | 90.5 |
| | 10th sheet | 95.0 | 95.8 | 96.9 | 92.7 | 89.2 |
| | 20th sheet | 93.5 | 95.9 | 96.7 | 91.4 | 88.5 |
| | 40th sheet | 93.2 | 94.8 | 97.2 | 90.7 | 86.2 |
| | 60th sheet | 94.0 | 95.2 | 97.0 | 89.4 | 87.6 |
| | 80th sheet | 93.5 | 96.0 | 96.8 | 88.4 | 87.0 |
| | 100th sheet | 94.6 | 96.3 | 97.3 | 98.5 | 86.4 |

As is apparent from the results shown in Table 3-5, when using the electrophotographic toner of Comparative Example 3-1 in which the toner particles are produced by a melt blown method and an inclination value Sυ of melt viscosity-temperature characteristics of the toner including the toner particles exceeds 1×10⁴ Pa·S/° C., in the case of continuously forming an image under low temperature and low humidity conditions, fixing properties of the toner particles are deteriorated and retention of the image density decreases to less than 90% in the formed image after printing 60 sheets as the temperature of the fixing roller decreases.

The reason is considered as follows. Namely, a wax in the toner components was aggregated again in the drawing step and thus the amount of the wax contained in the individual toner particles produced through the cutting step largely varies. Particularly in the cut surface of the cylindrical fiber, the wax exposed in a large area falls from the toner particles in the subsequent process, and thus fixing properties at low temperature are deteriorated.

When using the electrophotographic toner of Comparative Example 3-2 in which toner particles are produced by a melt blown method and also an inclination value Sυ of melt viscosity-temperature characteristics of the toner including the toner particles is 1×10⁴ Pa·S/° C. or lower, but the melting point of the wax exceeds 100° C., in the case of continuously forming an image under low temperature and low humidity conditions, fixing properties of the toner particles are deteriorated and retention of the image density decreases to less than 90% in the formed image after printing 10 sheets as the temperature of the fixing roller decreases.

In contrast, when using the electrophotographic toners of Examples 3-1 to 3-3 in which the toner particles are produced by a melt blown method and also an inclination value Sυ of melt viscosity-temperature characteristics of the toner including the toner particles is 1×10⁴ Pa·S/° C. or lower, and the melting point of the wax is 100° C. or lower, in the case of continuously forming an image under low temperature and low humidity conditions, it was confirmed that fixing properties of the toner particles can be satisfactorily maintained after printing 1 to 100 sheets and retention of the image density can be maintained to 90% or more even if the temperature of the fixing roller decreases.

### Example 4

### Synthesis of Binder Resin

A monomer solution comprising 70 parts by weight of styrene and 30 parts by weight of butyl acrylate was added dropwise in a solution (equipped with a capacitor, toluene is refluxed) containing 6 parts by weight of V-65 (2,2-azobis-(2,4-dimethylvaleronitrile) manufactured by Wako Pure Chemical Industries, Ltd. as a polymerization initiator and 200 parts by weight of toluene as a solvent over 3 hours. After the dropwise addition, the mixture was polymerized for an additional 12 hours while maintaining at 60° C. and toluene was removed by distillation under reduced pressure to produce a binder resin (styrene-acrylic resin).

### (Preparation of Non-Magnetic Toner)

Using, as toner materials, 100 parts by weight of the binder resin composed of the styrene-acrylic resin thus obtained, 4 parts by weight of carbon black (MA-100: manufactured by Mitsubishi Chemical Corporation) as a colorant, 2 parts by weight of a charge control agent (N-01: manufactured by Orient Chemical Industries, Ltd.) and 5 parts by weight of wax (FT-100: manufactured by Nippon Seiro Co., Ltd.) as a releasant, cylindrical toner particles were obtained by the melt blown method using the apparatuses shown in FIG. 2 and FIG. 3. The resulting cylindrical toner particles were subjected to a spheroidization treatment using a spherodizing device (Faculty Model F-400 manufactured by Hosokawa Micron Corporation) to obtain toner particles in the form of an elliptical body (see FIG. 5) having a major diameter a of 7 to 8.5 μm and a minor diameter b of 5 μm on average. The toner particles were mixed with 1.2% of silica: RA-200H (manufactured by Nippon Aerogyl Co., Ltd.) as an external additive in a Henschel mixer (manufactured by Mitsui Mining Co., Ltd.) to obtain non-magnetic toners of Examples 4-1 to 4-5 and Comparative Examples 4-1 to 4-9. The non-magnetic toner thus obtained was used as a two-component developer after mixing with a magnetic carrier.

### Example 4-1

As the non-magnetic toner, a toner obtained by the above method, in which the toner particles have a value a/b of 1.4 obtained by dividing a major diameter a of the toner particles by a minor diameter b, a standard deviation of particle size distribution of the toner particles of 0.98 and an average circularity of the toner particles of 0.935, was used.

### Example 4-2

As the non-magnetic toner, a toner obtained by the above method, in which the toner particles have a value a/b of 1.5 obtained by dividing a major diameter a of toner particles by a minor diameter b, a standard deviation of particle size distribution of the toner particles of 0.99 and an average circularity of the toner particles of 0.945, was used.

### Example 4-3

As the non-magnetic toner, a toner obtained by the above method, in which the toner particles have a value a/b of 1.0 obtained by dividing a major diameter a of the toner particles by a minor diameter b, a standard deviation of particle size distribution of the toner particles of 0.98 and an average circularity of the toner particles of 0.948, was used.

### Example 4-4

As the non-magnetic toner, a toner obtained by the above method, in which the toner particles have a value a/b 2.0 obtained by dividing a major diameter a of the toner particles by a minor diameter b, a standard deviation of particle size distribution of the toner particles of 0.98 and an average circularity of the toner particles of 0.922, was used.

### Example 4-5

As the non-magnetic toner, a toner obtained by the above method, in which the toner particles have a value a/b of 1.3 obtained by dividing a major diameter a of toner particles by a minor diameter b, a standard deviation of particle size distribution of the toner particles of 0.96 and an average circularity of the toner particles of 0.950, was used.

### Comparative Example 4-1

As the non-magnetic toner, a toner obtained by the above method, in which the toner particles have a value a/b of 1.4 obtained by dividing a major diameter a of the toner particles by a minor diameter b, a standard deviation of particle size distribution of the toner particles of 1.18 and an average circularity of the toner particles of 0.934, was used.

### Comparative Example 4-2

As the non-magnetic toner, a toner obtained by the above method, in which the toner particles have a value a/b of 1.7 obtained by dividing a major diameter a of the toner particles by a minor diameter b, a standard deviation of particle size distribution of the toner particles of 0.99 and an average circularity of the toner particles of 0.898, was used.

### Comparative Example 4-3

As the non-magnetic toner, a toner obtained by the above method, in which the toner particles have a value a/b of 1.8 obtained by dividing a major diameter a of toner particles by a minor diameter b, a standard deviation of particle size distribution of the toner particles of 0.99 and an average circularity of the toner particles of 0.912, was used.

### Comparative Example 4-4

As the non-magnetic toner, a toner obtained by the above method, in which the toner particles have a value a/b 1.6 obtained by dividing a major diameter a of toner particles by a minor diameter b, a standard deviation of particle size distribution of the toner particles of 0.95 and an average circularity of the toner particles of 0.965, was used.

### Comparative Example 4-5

As the non-magnetic toner, a toner obtained by the above method, in which the toner particles have a value a/b of 1.8 obtained by dividing a major diameter a of toner particles by a minor diameter b, a standard deviation of particle size distribution of the toner particles of 1.20 and an average circularity of the toner particles of 0.901, was used.

### Comparative Example 4-6

As the non-magnetic toner, a toner obtained by the above method, in which the toner particles have a value a/b of 1.5 obtained by dividing a major diameter a of toner particles by a minor diameter b, a standard deviation of particle size distribution of the toner particles of 1.20 and an average circularity of the toner particles of 0.955, was used.

### Comparative Example 4-7

Using, as toner materials, 100 parts by weight of the binder resin composed of the styrene-acrylic resin thus obtained, 4 parts by weight of carbon black (MA-100: manufactured by Mitsubishi Chemical Corporation) as a colorant, 2 parts by weight of a charge control agent (N-01: manufactured by Orient Chemical Industries, Ltd.) and 5 parts by weight of a wax (FT-100: manufactured by Nippon Seiro Co., Ltd.) as a releasant, toner particles having a volume average particle size of 6.5 μm were produced by a grinding method including a melt-kneading step, a coarse grinding step, a fine grinding step and a classifying step. The resulting toner particles were mixed with 1.2% of silica: RA-200H (manufactured by Nippon Aerogyl Co., Ltd.) as an external additive in a Henschel mixer (manufactured by Mitsui Mining Co., Ltd.) to prepare a non-magnetic toner. The non-magnetic toner thus obtained was used as a two-component developer after mixing with a magnetic carrier.

As the non-magnetic toner, a toner including the toner particles having a standard deviation of particle size distribution of the toner particles of 1.15 and an average circularity of the toner particles of 0.927 was used.

### Comparative Example 4-8

As the non-magnetic toner, a toner which is obtained using the same materials and method as in Comparative Example 4-7 and includes the toner particles having a standard deviation of particle size distribution of the toner particles of 0.99 and an average circularity of the toner particles of 0.930, was used.

### Comparative Example 4-9

As the non-magnetic toner, a toner which is obtained using the same materials and method as in Comparative Example 4-7 and includes the toner particles having a standard deviation of particle size distribution of the toner particles of 1.31 and an average circularity of the toner particles of 0.911, was used.

In Comparative Examples 4-7, 4-8 and 4-9, since toner particles are produced by a grinding method, the shape thereof is close to a sphere, and thus a major diameter and minor a diameter do not exist. Therefore, the value a/b was not determined.

### (Measuring Method)

The average circularity of the toner particles was measured using a flow particle image analyzer (FPIA-2100 manufactured by Sysmex Corporation) under an environment at 23° C. and 60% RH and the measured particles had a circle equivalent diameter within a range from 0.60 to 400 μm. Then, the circularity E_{S} of the measured particles was determined by the following equation and also a value obtained by dividing the sum total of circularities of particles each having a circle equivalent diameter of 2 μm or more and 10 μm or less by the number of entire particles was defined as the average circularity.

E_{S}=L₀/L

where L₀ denotes the peripheral length of a circle having the same projection area as that of a particle projection image, and L denotes the peripheral length of the particle projection image when image-analyzed at an image analyzing resolution of 512×512 (picture element measuring 0.3 μm×0.3 μm).

The standard deviation (SD value) of particle size distribution of the toner particles was measured using a Coulter Counter Multisizer 3 (manufactured by Beckman Coulter Co.). Specifically, 10 mg of a measuring sample was added in a solution prepared by adding a small amount of a surfactant in an electrolytic solution. After subjecting to a dispersion treatment using an ultrasonic wave distributor, volume distribution of the particle size of the sample was measured using the solution containing the measuring sample dispersed therein. ISOTONE II (manufactured by Beckman Coulter Co.) was used as the electrolytic solution and a 100 μm aperture was used as the aperture.

The value a/b (see FIG. 5) in which a major diameter a of toner particles is divided by a minor diameter b is determined by the following procedure. Namely, in SEM images (2,000 times magnification) of toner particles taken under a scanning electron microscope, 100 toner particles were selected at random from toner particles in the image, and then a major diameter a and a minor diameter b were measured and a ratio of the averaged measured value was obtained. The resulting value was rounded to two decimal places.

### (Evaluation of Performances)

With respect to the developers of Examples 4-1 to 4-5 and Comparative Examples 4-1 to 4-9, the occurrence of faulty cleaning was evaluated using a color page printer manufactured by KYOCERA MITA Corporation (printer obtained by modifying “FS-C5020N”) in which a fur brush cleaning method is employed as the cleaning method of an intermediate transfer belt.

After forming 100 solid image patterns on the first sheet, blank images formed on the second and third prints were visually observed and the occurrence of faulty cleaning was evaluated.

A: Satisfactory cleaning
B: Slightly faulty cleaning
C: Faulty cleaning

The evaluation results of performances are shown in Table 4.

TABLE 4

| | | a/b | SD | average | Faulty |
|---|---|---|---|---|---|
| | Method | value | value | circularity | cleaning |
| Example 4-1 | melt blown method | 1.4 | 0.98 | 0.935 | A |
| Example 4-2 | melt blown method | 1.5 | 0.99 | 0.945 | A |
| Example 4-3 | melt blown method | 1.0 | 0.98 | 0.948 | A |
| Example 4-4 | melt blown method | 2.0 | 0.98 | 0.922 | A |
| Example 4-5 | melt blown method | 1.3 | 0.96 | 0.950 | A |
| Comparative | melt blown method | 1.4 | 1.18 | 0.934 | B |
| Example 4-1 | | | | | |
| Comparative | melt blown method | 1.7 | 0.99 | 0.898 | B |
| Example 4-2 | | | | | |
| Comparative | melt blown method | 1.8 | 0.99 | 0.912 | B |
| Example 4-3 | | | | | |
| Comparative | melt blown method | 1.6 | 0.95 | 0.965 | B |
| Example 4-4 | | | | | |
| Comparative | melt blown method | 1.8 | 1.20 | 0.901 | C |
| Example 4-5 | | | | | |
| Comparative | melt blown method | 1.5 | 1.20 | 0.955 | C |
| Example 4-6 | | | | | |
| Comparative | grinding method | — | 1.15 | 0.927 | c |
| Example 4-7 | | | | | |
| Comparative | grinding method | — | 0.99 | 0.930 | C |
| Example 4-8 | | | | | |
| Comparative | grinding method | — | 1.31 | 0.911 | C |
| Example 4-9 | | | | | |

It has been found that the toners of Examples 4-1 to 4-5 which contain the toner particles in the form of an elliptical body obtained by a melt blown method, the toner particles having an average circularity of the toner particles of 0.92 or more and 0.95 or less and a standard deviation of particle size distribution of the toner particles of 1.00 μm or less, faulty cleaning can be found. It has also been found that slight faulty cleaning is observed in the toner of Comparative Example 4-1 in which the standard deviation of particle size distribution of the toner particles exceeds 1.00 μm and the toners of Comparative Example 4-2 and Comparative Example 4-3 in which the average circularity of the toner particles is not within the above range. Also, in the toners of Comparative Examples 4-4, 4-5 and 4-6 in which both standard deviation and average circularity are not within the above ranges, faulty cleaning was observed. Furthermore, in the toners of Comparative Examples 4-7, 4-8 and 4-9 in which toner particles are obtained by a grinding method, faulty cleaning was observed.

### Example 5

### Production of Toner Particles

As toner components, a styrene-acrylic resin as a binder resin, carbon black (MA100 manufactured by Mitsubishi Chemical Corporation) as a colorant, a wax (FT100 manufactured by Nippon Seiro Co., Ltd.) and a positive charge control agent (manufactured by Orient Chemical Industries, Ltd. under the trade name of BONTRON P-51) were supplied to the premixing device 7 during the production process of FIG. 2 described above in the proportions shown in Table 5-1 below.

TABLE 5-1

| Component | Parts by mass |
|---|---|
| binder resin | 100 |
| colorant | 4 |
| wax | 5 |
| positive charge control agent | 2 |

In accordance with the production processes of FIG. 2 and FIG. 3, as described above, the toner components were subjected to various steps such as premixing using a premixing device 7, kneading using a single screw extruder 1, adjustment of pressure and extrusion amount using a gear pump 4, additional kneading in a static mixer 2 and a flow passage structure 3, extrusion through nozzles 6, drawing using a hot blast and quenching using a cold blast to produce multiple fiber-like materials 12 in the form of a cylindrical fiber. The multiple fiber-like materials 12 were air-cooled while conveying on a belt conveyor 11 and then cut by a fiber cutting device 8 to continuously produce four kinds of cylindrical toner particles, Nos. 1 to 4, in which a length a in an axis direction of a cylinder, a length b in a diameter direction (see FIG. 6) and a center particle size on volume basis vary respectively as shown in Table 5-2. The length a in an axis direction of the cylinder corresponding to a cut length of the fiber-like material 12 was adjusted by the ratio of the conveying speed of the fiber-like material 12 to the rotary speed of the rotary knife 10.

TABLE 5-2
Toner particles

| | | | | Center |
|---|---|---|---|---|
| | | | | particle |
| No. | a (μm) | b (μm) | a/b | size (μm) |
| 1 | 7.5 | 5.0 | 1.5 | 6.5 |
| 2 | 5.0 | 5.0 | 1.0 | 5.1 |
| 3 | 10.0 | 5.0 | 2.0 | 7.7 |
| 4 | 12.0 | 5.0 | 2.4 | 8.6 |

(Silica)

As the external additive, nine kinds of silica, Nos. A to I, in which the primary particle size measured by the above-described method, the total amount of aminosilane and silicone oil as surface treating agents (a mixing ratio of the agents is 1:1 in terms of a mass ratio) and a charge amount have respectively the values shown in Table 5-3, were prepared.

TABLE 5-3
Silica

| | Primary | Amount of surface | |
|---|---|---|---|
| | particle size | treating agent | Charge amount |
| No. | (nm) | added (% by mass) | (μC/g) |
| A | 17 | 4.1 | 420 |
| B | 17 | 4.5 | 500 |
| C | 17 | 4.8 | 580 |
| D | 11 | 4.8 | 500 |
| E | 23 | 4.2 | 500 |
| F | 17 | 3.9 | 375 |
| G | 17 | 5.1 | 625 |
| H | 8 | 5.1 | 500 |
| I | 27 | 4.0 | 500 |

Details of the blow off method for measuring the charge amount of silica are as follows.

### (Measurement of Charge Amount of Silica)

100 g of a carrier obtained by coating the surface of a Mn/Mg core having a weight average particle size of 35 μm with a silicone resin in an amount of 30 parts by mass based on 1,000 parts by mass of the core and 0.40 g of silica as a measuring sample were placed in a polypropylene bottle having a volume of 500 ml under a normal temperature and a normal humidity environment at a temperature of 20 to 23° C. and a relative humidity of 50 to 65% RH and then mixed by rotating at 75 to 100 rpm for 3 minutes in a state of closing the bottle using a ball mill (manufactured by KYOCERA MITA Corporation). Using a blow-off charge amount measuring device TB-200 manufactured by KYOCERA Chemical Corporation, a charge amount of silica was measured by a blow off method at a blow pressure of 0.60 kgf and a blow time of 180 seconds under the conditions of a measuring range 1.

### Examples 5-1 to 5-7 and Comparative Examples 5-1 to 5-5

Using four kinds of the toner particles and nine kinds of the silica(s) in combination in accordance with combinations shown in Table 5-4, non-magnetic one-component toners were prepared. Specifically, 100 parts by mass of toner particles, 1.0 parts by mass of silica as an external additive and 1.0 parts by mass of titanium oxide (EC-100 manufactured by Titan Kogyo Co., Ltd.) as the other external additive were mixed using a Henschel mixer (manufactured by Mitsui Mining Co., Ltd.) to prepare non-magnetic one-component toners.

### (Actual Machine Test)

Using non-magnetic one-component toners of the respective Examples and Comparative Examples and a modified version of a laser facsimile device LCD-790 manufactured by KYOCERA MITA Corporation (modifying a developing method to a non-contact type non-magnetic one-component developing method), an image was formed under a normal temperature and a normal humidity environment at a temperature of 20 to 23° C. and a relative humidity of 50 to 65% RH and then the following evaluation was conducted.

### (Observation of Image Unevenness)

After an image of a standard pattern (printing rate of 5%) was formed under the normal temperature and normal humidity environment, thin layers of a non-magnetic one-component toner formed on the surface of a developing sleeve as the developer supporting material were observed and also the first formed image was observed, and then it was evaluated whether or not image unevenness occurred according to the following criteria. Then, after an image of a standard pattern (printing rate of 5%) was continuously formed on 100,000 sheets, thin layers of the non-magnetic one-component toner formed on the surface of the developing sleeve were observed and also the 100,000th formed image, and then it was evaluated whether or not image unevenness occurred according to the following criteria.

A: Unevenness was not observed in thin layers on a developing sleeve and also image unevenness was not observed in the formed image, and thus it was evaluated that any image unevenness is not occurred.
B: While unevenness was observed in thin layers on a developing sleeve, image unevenness was not observed in the formed image and thus it was evaluated that image unevenness is scarcely occurred.
C: Unevenness was observed in thin layers on a developing sleeve and also slight image unevenness was observed in the formed image, and thus it was evaluated that image unevenness is slightly occurred.
D: Unevenness was observed in thin layers on a developing sleeve and also image unevenness was observed in the formed image, and thus it was evaluated that image unevenness is occurred.

### (Measurement of Image Density)

After an image of a standard pattern (printing rate of 5%) was continuously formed on 100,000 sheets under the normal temperature and normal humidity environment, the image density of the solid portion of the first formed image and the 100,000th formed image was measured using a Macbeth reflection densitometer (RD914 manufactured by Gretagmacbeth Corp.).

### (Measurement of Fog Density)

After an image of a standard pattern (printing rate of 5%) was continuously formed on 100,000 sheets under the normal temperature and normal humidity environment, the image density of the margin portion of the first formed image and the 100,000th formed image was measured using a reflection densitometer (TC-6D manufactured by Tokyo Denshoku Co., Ltd.).

### (Observation of Dashmark)

After an image of a standard pattern (printing rate of 5%) was continuously formed 100,000 sheets under the normal temperature and normal humidity environment, the 100,000th formed image and the surface of a photoconductor drum as an image supporting material were observed and it was evaluated whether or not dashmark occurred.

A: Adhesion of silica was not observed on the surface of a photoconductor drum and any dashmark was not observed in the formed image, and thus it was evaluated that any dashmark is not occurred.
B: Adhesion of silica was observed on the surface of a photoconductor drum but dashmark was not observed in the formed image, and thus it was evaluated that dashmark is scarcely occurred.
C: Adhesion of silica was observed on the surface of a photoconductor drum and also slight dashmark was observed in the formed image, and thus it was evaluated that dashmark is slightly occurred.
D: Adhesion of silica was observed on the surface of a photoconductor drum and also dashmark was observed in the formed image, and thus it was evaluated that dashmark is occurred.

The above results are shown in Table 5-4.

TABLE 5-4

| | | | | | | | Actual machine test | | | | | | |
|---|---|---|---|---|---|---|---|---|---|---|---|---|---|
| | | | | | | | (under normal temperature and normal humidity environment) | | | | | | |
| | | Toner | | Silica | | | First sheet | | | 100,000th sheet | | | |
| | | particles | | | Primary | | Image | Image | | Image | Image | Fog | Dash- |
| | | No. | a/b | No. | particle | Charge | unevenness | density | Fog density | unevenness | density | density | mark |
| Examples | 5-1 | 1 | 1.5 | A | 17 | 420 | A | 1.29 | 0.002 | B | 1.35 | 0.005 | A |
| | 5-2 | 1 | 1.5 | B | 17 | 500 | A | 1.36 | 0.003 | B | 1.44 | 0.006 | A |
| | 5-3 | 1 | 1.5 | C | 17 | 580 | A | 1.48 | 0.004 | B | 1.54 | 0.008 | A |
| | 5-4 | 1 | 1.5 | D | 11 | 500 | A | 1.28 | 0.003 | A | 1.33 | 0.005 | A |
| | 5-5 | 1 | 1.5 | E | 23 | 500 | A | 1.41 | 0.004 | B | 1.49 | 0.007 | A |
| | 5-6 | 2 | 1.0 | B | 17 | 500 | A | 1.37 | 0.004 | B | 1.45 | 0.005 | A |
| | 5-7 | 3 | 2.0 | B | 17 | 500 | A | 1.36 | 0.003 | B | 1.42 | 0.005 | A |
| Comparative | 5-1 | 1 | 1.5 | F | 17 | 375 | A | 1.01 | 0.002 | C | 0.80 | 0.012 | A |
| Examples | 5-2 | 1 | 1.5 | G | 17 | 625 | A | 1.45 | 0.004 | — | — | — | D |
| | 5-3 | 1 | 1.5 | H | 8 | 500 | A | 1.23 | 0.004 | — | — | — | C |
| | 5-4 | 1 | 1.5 | I | 27 | 500 | A | 1.35 | 0.003 | B | 1.25 | 0.006 | B |
| | 5-5 | 4 | 2.4 | B | 17 | 500 | A | 1.31 | 0.004 | D | 0.88 | 0.011 | D |

In case of the non-magnetic one-component toner of Comparative Example 5-1 in which silica having a charge amount of less than 400 μC/g is used, the first formed image had insufficient image density because of insufficient chargeability. The image density further decreased by continuously forming an image on 100,000 sheets and also fog occurred and the fog density drastically increased. In case of the non-magnetic one-component toner of Comparative Example 5-2 in which silica having a charge amount of more than 600 μC/g is used, since a number of dasmark occurred in the 100,000th formed image, the evaluation was abandoned.

In case of the non-magnetic one-component toner of Comparative Example 5-3 in which silica having a primary particle size of less than 10 nm is used, silica was embedded in toner particles and the effect was lost during the formation of a continuous image and thus the image density drastically decreased and also image unevenness occurred. Therefore, with respect to the 100,000th formed image, only dashmark was observed and other evaluations were abandoned. In case of the non-magnetic one-component toner of Comparative Example 5-5 in which toner particles having a ratio a/b of a length a in an axis direction of a cylinder to a length b in a diameter direction of more than 2 is used, since adhesion to the developing sleeve is too large, the image density drastically decreased by continuously forming an image on 100,000 sheets and also fog occurred and the fog density drastically increased. In the 100,000th formed image, dashmark occurred.

In contrast, when using the non-magnetic one-component toners of Example 5-1 to 5-7 in which toner particles having a ratio a/b of a length a in an axis direction of a cylinder to a length b in a diameter direction of 2 or less is used in combination with silica having a primary particle size of 10 to 25 nm and a charge amount of 400 to 600 μC/g, any image unevenness did not occur or occurred scarcely and any dashmark did not occur. It was confirmed that an excellent image having a high image density and a low fog density can be formed for a long period.

In the non-magnetic one-component toner of Comparative Example 5-4 in which silica having a primary particle size of more than 25 nm, good results was obtained under a normal temperature and a normal humidity environment similar to Examples 5-1 to 5-7. However, when each test was conducted under high temperature and high humidity conditions at a temperature of 33° C. and a relative humidity of 85% RH, fluidity drastically decreased. As shown in Table 5-5 below, image unevenness occurred and also slight dashmark occurred after an image was continuously formed on 100,000 sheets. In contrast, it was confirmed that good results can be maintained even under high temperature and high humidity conditions in the non-magnetic one-component toners of Examples 5-1 to 5-7.

TABLE 5-5

| | | Actual machine test | | | | | | |
|---|---|---|---|---|---|---|---|---|
| | | (under high temperature and high humidity environment) | | | | | | |
| | | First sheet | | | 100,000th sheet | | | |
| | | Image | Image | Fog | Image | Image | Fog | |
| | | unevenness | density | density | unevenness | density | density | Dashmark |
| Examples | 5-1 | A | 1.25 | 0.003 | B | 1.31 | 0.004 | A |
| | 5-2 | A | 1.31 | 0.003 | B | 1.40 | 0.005 | A |
| | 5-3 | A | 1.41 | 0.003 | B | 1.50 | 0.006 | A |
| | 5-4 | A | 1.24 | 0.002 | A | 1.30 | 0.005 | A |
| | 5-5 | A | 1.37 | 0.003 | B | 1.44 | 0.007 | A |
| | 5-6 | A | 1.32 | 0.004 | B | 1.40 | 0.006 | A |
| | 5-7 | A | 1.31 | 0.003 | B | 1.38 | 0.006 | A |

| | | | | | | | |
|---|---|---|---|---|---|---|---|
| Comparative | C | 1.24 | 0.003 | D | 1.10 | 0.006 | C |
| Example 5-4 | | | | | | | |

### Example 6

### Preparation of Toner Particles

As the toner components, a polyester-based resin as a binder resin, carbon black (MA100 manufactured by Mitsubishi Chemical Corporation) as a colorant, a wax (FT100 manufactured by Nippon Seiro Co., Ltd.) and a positive charge control agent (manufactured by Orient Chemical Industries, Ltd. under the trade name of N-01) were supplied to the premixing device 7 during the production process of FIG. 2 described above in the proportion shown in Table 6-1 below.

TABLE 6-1

| Component | Parts by mass |
|---|---|
| Binder resin | 100 |
| Colorant | 4 |
| Wax | 5 |
| Positive charge control agent | 2 |

In accordance with the production processes of FIG. 2 and FIG. 3, as described above, the toner components were subjected to various steps such as premixing using a premixing device 7, kneading using a single screw extruder 1, adjustment of pressure and extrusion amount using a gear pump 4, additional kneading in a static mixer 2 and a flow passage structure 3, extrusion through nozzles 6, drawing using a hot blast and quenching using a cold blast to produce multiple fiber-like materials 12 in the form of a cylindrical fiber. The multiple fiber-like materials 12 were air-cooled while conveying on a belt conveyor 11 and then cut by a fiber cutting device 8 to continuously produce four kinds of cylindrical toner particles, Nos. 1 to 4, in which a length a in an axis direction of a cylinder, a length b in a diameter direction (see FIG. 6) and a center particle size on volume basis vary respectively as shown in Table 6-2. The length a in an axis direction of a cylinder corresponding to a cut length of the fiber-like material 12 was adjusted by the ratio of the conveying speed of the fiber-like material 12 to the rotary speed of the rotary knife 10.

TABLE 6-2
Toner particles

| | | | | Center |
|---|---|---|---|---|
| | | | | particle |
| No. | a (μm) | b (μm) | a/b | size (μm) |
| 1 | 7.5 | 5.0 | 1.5 | 6.5 |
| 2 | 5.0 | 5.0 | 1.0 | 5.1 |
| 3 | 10.0 | 5.0 | 2.0 | 7.7 |
| 4 | 12.0 | 5.0 | 2.4 | 8.6 |

(Silica)

As the external additive, nine kinds of silica, Nos. A to I, in which the primary particle size measured by the above-described method, the total amount of aminosilane and silicone oil as surface treating agents (a mixing ratio of the agents is 1:1 in terms of a mass ratio) and a charge amount have respectively the values shown in Table 6-3, were prepared.

TABLE 6-3
Silica

| | Primary | Amount of surface | |
|---|---|---|---|
| | particle size | treating agent | Charge amount |
| No. | (nm) | added (% by mass) | (μC/g) |
| A | 17 | 3.8 | 320 |
| B | 17 | 4.3 | 450 |
| C | 17 | 4.8 | 580 |
| D | 11 | 4.6 | 460 |
| E | 23 | 4.0 | 460 |
| F | 17 | 3.5 | 275 |
| G | 17 | 5.1 | 625 |
| H | 8 | 4.9 | 450 |
| I | 27 | 3.8 | 460 |

Details of the blow off method for measuring the charge amount of silica are as follows.

### (Measurement of Charge Amount of Silica)

100 g of a carrier obtained by coating the surface of a Mn/Mg core having a weight average particle size of 35 μm with a silicone resin in an amount of 30 parts by mass based on 1,000 parts by mass of the core and 0.40 g of silica as a measuring sample were placed in a polypropylene bottle having a volume of 500 ml under a normal temperature and a normal humidity environment at a temperature of 20 to 23° C. and a relative humidity of 50 to 65% RH and then mixed by rotating at 75 to 100 rpm for 3 minutes in a state of closing the bottle using a ball mill (manufactured by KYOCERA MITA Corporation). Using a blow-off charge amount measuring device TB-200 manufactured by KYOCERA Chemical Corporation, a charge amount of silica was measured by a blow off method at a blow pressure of 0.60 kgf and a blow time of 180 seconds under the conditions of a measuring range 1.

### Examples 6-1 to 6-7 and Comparative Examples 6-1 to 6-5

Using four kinds of the toner particles and nine kinds of the silica(s) in combination in accordance with combinations shown in Table 6-4, non-magnetic one-component toners were prepared. Specifically, 100 parts by mass of toner particles, 2.0 parts by mass of silica as an external additive and 1.0 parts by mass of titanium oxide (EC-100 manufactured by Titan Kogyo Co., Ltd.) as the other external additive were mixed using a Henschel mixer (manufactured by Mitsui Mining Co., Ltd.) to prepare toners for a two-component developer.

As a carrier, a carrier having a mass average particle size of 50 μm obtained by coating the surface of a Cu—Zn core with a resin coat layer was used. Then, the carrier and the toner for a two-component developer were mixed in a ratio (7 parts by mass of the toner for a two-component developer based on 100 parts by mass of the carrier) to prepare a two-component developer.

### (Actual Machine Test)

Using the two-component toners of the respective Examples and Comparative Examples as a start developing agent in a color laser printer FS-C5030N manufactured by KYOCERA MITA Corporation employing a hybrid developing method and using the same toner for a two-component developer as used as the toner for a two-component developer as a replenishing toner, an image was formed under a normal temperature and a normal humidity environment at a temperature of 20 to 23° C. and a relative humidity of 50 to 65% RH and then the following evaluation was conducted.

### (Observation of Image Unevenness)

After an image of a standard pattern (printing rate of 5%) was formed on one sheet under the normal temperature and normal humidity environment, thin layers of a non-magnetic one-component toner formed on the surface of a developing sleeve as the developer supporting material were observed and also the first formed image was observed, and then it was evaluated whether or not image unevenness occurred according to the following criteria. Then, after an image of a standard pattern (printing rate of 5%) was continuously formed on 100,000 sheets, thin layers of the non-magnetic one-component toner formed on the surface of the developing sleeve were observed and also the 100,000th formed image, and then it was evaluated whether or not image unevenness occurred according to the following criteria.

A: Unevenness was not observed in thin layers on a developing sleeve and also image unevenness was not observed in the formed image, and thus it was evaluated that any image unevenness is not occurred.
B: While unevenness was observed in thin layers on a developing sleeve, image unevenness was not observed in the formed image and thus it was evaluated that image unevenness is scarcely occurred.
C: Unevenness was observed in thin layers on a developing sleeve and also slight image unevenness was observed in the formed image, and thus it was evaluated that image unevenness is slightly occurred.
D: Unevenness was observed in thin layers on a developing sleeve and also image unevenness was observed in the formed image, and thus it was evaluated that image unevenness is occurred.

### (Measurement of Image Density)

After an image of a standard pattern (printing rate of 5%) was continuously formed on 100,000 sheets under the normal temperature and normal humidity environment, the image density of the solid portion of the first formed image and the 100,000th formed image was measured using a Macbeth reflection densitometer (RD914 manufactured by Gretagmacbeth Corp.).

### (Measurement of Fog Density)

After an image of a standard pattern (printing rate of 5%) was continuously formed on 100,000 sheets under the normal temperature and normal humidity environment, the image density of the margin portion of the first formed image and the 100,000th formed image was measured using a reflection densitometer (TC-6D manufactured by Tokyo Denshoku Co., Ltd.).

### (Measurement of Toner Scatter Amount)

After an image of a standard pattern (printing rate of 5%) was continuously formed on 100,000 sheets under the normal temperature and normal humidity environment, a two-component toner for developer accumulated in a vertical direction of a developing sleeve of developing means, as a result of scatter of charged defect, was collected by sucking using a sucking-type portable charge amount measuring device (Q/M meter 210HS manufactured by TREK Japan Co., Ltd.), weighed using an electronic balance and then recorded as a toner scatter amount. Assuming that a threshold value of the toner scatter amount is 500 mg, the sample where the toner scatter amount exceeds 500 mg was rated as “Fail”.

The above results are shown in Table 6-4.

TABLE 6-4

| | | | | | | | Actual machine test | | | | | | |
|---|---|---|---|---|---|---|---|---|---|---|---|---|---|
| | | | | Silica | | | (under normal temperature and normal humidity environment) | | | | | | |
| | | | | | Primary | | | | | 100,000th sheet | | | |
| | | Toner | | | particle | Charge | First sheet | | | | | | toner |
| | | particles | | | size | amount | Image | Image | Fog | Image | Image | Fog | scatter |
| | | No. | a/b | No. | (nm) | (μC/g) | unevenness | density | density | unevenness | density | density | amount |
| Examples | 6-1 | 1 | 1.5 | A | 17 | 320 | A | 1.61 | 0.002 | B | 1.47 | 0.005 | 56 |
| | 6-2 | 1 | 1.5 | B | 17 | 450 | A | 1.53 | 0.003 | B | 1.46 | 0.005 | 210 |
| | 6-3 | 1 | 1.5 | C | 17 | 580 | A | 1.37 | 0.003 | B | 1.49 | 0.004 | 450 |
| | 6-4 | 1 | 1.5 | D | 11 | 460 | A | 1.55 | 0.002 | A | 1.35 | 0.007 | 245 |
| | 6-5 | 1 | 1.5 | E | 23 | 460 | A | 1.55 | 0.001 | B | 1.50 | 0.006 | 245 |
| | 6-6 | 2 | 1.0 | B | 17 | 450 | A | 1.57 | 0.002 | B | 1.44 | 0.005 | 220 |
| | 6-7 | 3 | 2.0 | B | 17 | 450 | A | 1.53 | 0.004 | B | 1.45 | 0.006 | 220 |
| Comparative | 6-1 | 1 | 1.5 | F | 17 | 275 | A | 1.55 | 0.002 | — | — | — | 1200 |
| Examples | 6-2 | 1 | 1.5 | G | 17 | 625 | A | 1.35 | 0.003 | — | — | — | 800 |
| | 6-3 | 1 | 1.5 | H | 8 | 450 | A | 1.60 | 0.002 | D | 0.80 | 0.004 | 300 |
| | 6-4 | 1 | 1.5 | I | 27 | 460 | A | 1.48 | 0.002 | B | 1.26 | 0.006 | 380 |
| | 6-5 | 4 | 2.4 | B | 17 | 450 | A | 1.42 | 0.001 | D | 1.10 | 0.010 | 420 |

In case of the toner for a two-component developer of Comparative Example 6-1 in which silica having a charge amount of less than 300 μC/g is used, the toner scatter amount drastically increased after printing about 20,000 sheets because of insufficient chargeability. At the time of the completion of continuous formation of an image on 100,000 sheets, the toner scatter amount reached 1,200 mg which exceeds the above threshold value severely and therefore the evaluation was abandoned. In case of toner for a two-component developer of Comparative Example 6-2 in which silica having a charge amount of more than 600 μC/g is used, carrier contamination with silica occurred and also the toner scatter amount drastically increased after printing about 20,000 sheets. At the time of the completion of continuous formation of an image on 100,000 sheets, the toner scatter amount reached 800 mg which exceeds the above threshold value and therefore the evaluation was abandoned.

In case of the toner for a two-component developer of Comparative Example 6-3 in which silica having a primary particle size of less than 10 nm is used, silica was embedded in toner particles and the effect was lost during the formation of a continuous image and thus the image density drastically decreased and also image unevenness occurred. In case of the toner for a two-component developer of Comparative Example 6-5 in which toner particles having a ratio a/b of a length a in an axis direction of a cylinder to a length b in a diameter direction of more than 2 is used, since adhesion to the developing sleeve is too large, the image density drastically decreased by continuously forming an image on 100,000 sheets and also fog occurred and the fog density drastically increased.

In contrast, when using the toners for a two-component developer of Example 6-1 to 6-7 in which toner particles having a ratio a/b of a length a in an axis direction of a cylinder to a length b in a diameter direction of 2 or less is used in combination with silica having a primary particle size of 10 to 25 nm and a charge amount of 300 to 600 μC/g, any image unevenness did not occur or occurred scarcely while suppressing the toner scatter amount to the threshold value or less. It was confirmed that an excellent image having a high image density and a low fog density can be formed for a long period.

In the toner for a two-component developer of Comparative Example 6-4 in which silica having a primary particle size of more than 25 nm, good results was obtained under a normal temperature and a normal humidity environment similar to Examples 6-1 to 6-7. However, when each test was conducted under high temperature and high humidity conditions at a temperature of 33° C. and a relative humidity of 85% RH, fluidity drastically decreased. As shown in Table 6-5 below, the image density drastically decreased by continuously forming an image on 100,000 sheets and image unevenness occurred and also the toner scatter amount exceeded the above threshold value. In contrast, it was confirmed that good results can be maintained even under high temperature and high humidity conditions in the non-magnetic one-component toners of Examples 6-1 to 6-7.

TABLE 6-5

| | | Actual machine test | | | | | | |
|---|---|---|---|---|---|---|---|---|
| | | (under high temperature and high humidity environment) | | | | | | |
| | | | | | 100,000th sheet | | | |
| | | | | | | | | Toner |
| | | first sheet | | | | | | scatter |
| | | Image | Image | Fog | Image | Image | Fog | amount |
| | | unevenness | Density | Density | unevenness | Density | Density | (mg) |
| Examples | 6-1 | A | 1.65 | 0.003 | B | 1.31 | 0.006 | 150 |
| | 6-2 | A | 1.60 | 0.004 | B | 1.40 | 0.006 | 310 |
| | 6-3 | A | 1.41 | 0.005 | B | 1.50 | 0.007 | 490 |
| | 6-4 | A | 1.45 | 0.003 | A | 1.30 | 0.007 | 330 |
| | 6-5 | A | 1.60 | 0.003 | B | 1.44 | 0.007 | 330 |
| | 6-6 | A | 1.60 | 0.004 | B | 1.40 | 0.006 | 380 |
| | 6-7 | A | 1.64 | 0.006 | B | 1.38 | 0.006 | 380 |

| | | | | | | | |
|---|---|---|---|---|---|---|---|
| Comparative | C | 1.61 | 0.003 | D | 1.10 | 0.006 | 900 |
| Example 6-4 | | | | | | | |

### Example 7

### Preparation of Non-Magnetic Toner Containing Cylindrical Toner Particles

A monomer solution containing 70 parts by weight of styrene and 30 parts by weight of butyl acrylate was added dropwise in a solution (equipped with a capacitor, toluene is refluxed) containing 6 parts by weight of V-65 (2,2-azobis-(2,4-dimethylvaleronitrile) manufactured by Wako Pure Chemical Industries, Ltd. as a polymerization initiator and 200 parts by weight of toluene as a solvent over 3 hours. After the dropwise addition, the mixture was polymerized for an additional 12 hours while maintaining at 60° C. and toluene was removed by distillation under reduced pressure to produce a binder resin (styrene-acrylic resin).

Using, as toner materials, 100 parts by weight of the binder resin (styrene-acrylic resin) thus obtained, 4 parts by weight of carbon black (MA-100: manufactured by Mitsubishi Chemical Corporation) as a colorant, 2 parts by weight of a charge control agent (N-01: manufactured by Orient Chemical Industries, Ltd.) and 5 parts by weight of a wax (FT-100: manufactured by Nippon Seiro Co., Ltd.) as a releasant, toner particles having a volume average particle size of 6.5 μm were produced by the above melt blown method using the devices shown in FIGS. 2 and 3. The resulting toner particles were mixed with 1.2% of silica: RA-200H (manufactured by Nippon Aerogyl Co., Ltd.) as an external additive in a Henschel mixer (manufactured by Mitsui Mining Co., Ltd.) to prepare a non-magnetic toner.

### (Image Forming Apparatus)

As an image forming apparatus, a tandem type laser color printer “LS-5020” (manufactured by KYOCERA MITA Corporation) was used. The intermediate transfer belt of this image forming apparatus has a multi-layered structure as shown in FIG. 8, in which a resin layer is made of polyvinylidene fluoride, an elastic layer is made of a CR rubber and a surface layer is made of Teflon®, respectively.

### Example 7-1

The above non-magnetic toner was used as the developer and the thickness of the intermediate transfer belt of the image forming apparatus was set to 300 μm (of which the thickness of the elastic layer is 200 μm).

### Example 7-2

The above non-magnetic toner was used as the developer and the thickness of the intermediate transfer belt of the image forming apparatus was set to 200 μm (of which the thickness of the elastic layer is 100 μm).

### Example 7-3

The above non-magnetic toner was used as the developer and the thickness of the intermediate transfer belt of the image forming apparatus was set to 100 μm (no plastic layer).

### Comparative Example 7-1

Using, as toner materials, 100 parts by weight of the same binder resin (styrene-acrylic resin) as that used to prepare the above cylindrical toner particles, 4 parts by weight of carbon black (MA-100: manufactured by Mitsubishi Chemical Corporation) as a colorant, 2 parts by weight of a charge control agent (N-01: manufactured by Orient Chemical Industries Ltd.) and 5 parts by weight of a wax (FT-100: manufactured by Nippon Seiro Co., Ltd.) as a releasant, toner particles having a volume average particle size of 6.5 μm were produced by a grinding method including a melt-kneading step, a coarse grinding step, a fine grinding step and a classifying step. The ground toner particles were mixed with 1.2% of silica: RA-200H (manufactured by Nippon Aerogyl Co., Ltd.) as an external additive in a Henschel mixer (manufactured by Mitsui Mining Co., Ltd.) to prepare a non-magnetic toner. The non-magnetic one-component toner was used as the developer and the thickness of the intermediate transfer belt of the image forming apparatus was set to 400 μm (of which the thickness of the elastic layer is 300 μm).

### Comparative Example 7-2

The non-magnetic toner produced by the grinding method of Comparative Example 7-1 was used as the developer and the thickness of the intermediate transfer belt of the image forming apparatus was set to 300 μm (of which the thickness of the elastic layer is 200 μm).

### Comparative Example 7-3

The non-magnetic toner produced by the grinding method of Comparative Example 7-1 was used as the developer and the thickness of the intermediate transfer belt of the image forming apparatus was set to 200 μm (of which the thickness of the elastic layer is 100 μm).

### Comparative Example 7-4

Using, as toner materials, 100 parts by weight of the same binder resin (styrene-acrylic resin) as that used to prepare the above cylindrical toner particles, 4 parts by weight of carbon black (MA-100: manufactured by Mitsubishi Chemical Corporation) as a colorant, 2 parts by weight of a charge control agent (N-01: manufactured by Orient Chemical Industries Ltd.) and 5 parts by weight of a wax (FT-100: manufactured by Nippon Seiro Co., Ltd.) as a releasant, toner particles having a volume average particle size of 6.5 μm were produced by a suspension polymerization method. The toner particles produced by the polymerization method were mixed with 1.2% of silica RA-200H (manufactured by Nippon Aerogyl Co., Ltd.) as an external additive in a Henschel mixer (manufactured by Mitsui Mining Co., Ltd.) to prepare a non-magnetic toner. The non-magnetic one-component toner was used as the developer and the thickness of the intermediate transfer belt of the image forming apparatus was set to 100 μm (no elastic layer).

### Comparative Example 7-5

The non-magnetic toner produced by the suspension polymerization method of Comparative Example 7-4 was used as the developer and the thickness of the intermediate transfer belt of the image forming apparatus was set to 200 μm (of which the thickness of the elastic layer is 100 μm).

### (Evaluation of Performances)

With respect to the eight kinds of developers and intermediate transfer belts of Examples 7-1 to 7-3 and Comparative Examples 7-1 to 7-5, images were formed based on an original copy having an original copy density of 4% under a normal temperature and a normal humidity environment at a temperature of 20° C. and a humidity of 65%, and then the following performances were evaluated.

### (i) Evaluation of Void Phenomenon

A void phenomenon was evaluated so as to confirm the effect of suppressing the occurrence of the void phenomenon according to the present embodiment. The evaluation was conducted by visually observing the copied images.

B: Void phenomenon did not occur.
D: Void phenomenon occurred.

### (ii) Evaluation of Color Shift

Color shift was evaluated so as to confirm the effect of suppressing the occurrence of distortion and color shift to a transfer image according to the present embodiment. The evaluation was conducted by visually observing the copied images.

B: No color shift occurred.
D: Color shift occurred.
(iii) Evaluation of Filming

Filming (occurrence of a so-called filming state where a developer is fixed onto the peripheral surface of an image supporting material) was evaluated so as to confirm cleaning properties according to the present embodiment. The evaluation was conducted by visually observing the surface of the image supporting material.

B: No filming occurred.
D: Filming occurred.

These performances were evaluated after an image forming treatment in which continuous printing of 100,000 sheets was carried out. As used herein, continuous printing means printing of continuously forming an image.

The evaluation results of performance are shown in Table 7.

TABLE 7

| | Method for | Thickness | | | |
|---|---|---|---|---|---|
| | producing | of belt | Void | Color | |
| | toner | (μm) | phenomenon | shift | Filming |
| Example 7-1 | Melt blown | 300 | B | B | B |
| | method | | | | |
| Example 7-2 | Melt blown | 200 | B | B | B |
| | method | | | | |
| Example 7-3 | Melt blown | 100 | B | B | B |
| | method | | | | |
| Comparative | grinding | 400 | B | D | B |
| Example 7-1 | method | | | | |
| Comparative | grinding | 300 | D | B | B |
| Example 7-2 | method | | | | |
| Comparative | grinding | 200 | D | B | B |
| Example 7-3 | method | | | | |
| Comparative | Suspension | 100 | B | B | D |
| Example 7-4 | polymerization | | | | |
| | method | | | | |
| Comparative | Suspension | 200 | B | B | D |
| Example 7-5 | polymerization | | | | |
| | method | | | | |

As is apparent from the test results shown in Table 7, in Examples 7-1 to 7-3 in which the thickness of an intermediate transfer belt was set to 300 μm or less, the occurrence of color shift can be suppressed as compared with Comparative Example 7-1 in which the thickness of an intermediate transfer belt exceeds 300 μm.

It was also found that, in Examples 7-1 to 7-3 in which the toner (developer) containing the cylindrical toner particles produced by a melt blown method, a void phenomenon did not occur as compared with Comparative Examples 7-2 and 7-3 in which a toner produced by a grinding method is used. It was also found that cleaning properties are excellent as compared with Comparative Examples 7-4 and 7-5 in which a toner produced by a suspension polymerization toner is used.

As described above, one aspect of the present invention pertains to a toner for a developer comprising cylindrical toner particles formed of a toner composition containing at least a binder resin and a releasant as toner components, and an external additive, wherein the cylindrical toner particles have an average circularity of 0.880 or more and 0.930 or less.

With the above constitution, since proper adhesion between the cylindrical toner particles and a magnetic carrier is maintained, scattering of the toner caused by separation of the toner from the magnetic carrier is prevented and thus it enables the toner to satisfactorily move toward an image supporting material. Also, passing of the toner through a cleaning device is reduced to obtain excellent cleaning properties. As a result, excellent tone and developability are attained.

The cylindrical toner particles are preferably formed by transforming the toner composition into a molten state, drawing the molten toner composition into a cylindrical fiber and cutting the cylindrical fiber.

With the above constitution, the cylindrical toner particles having the average circularity can be produced with excellent productivity.

Also, the cylindrical toner particles preferably have a standard deviation of particle size distribution of 1.20 μm or less.

With the above constitution, by sharp particle size distribution, namely, uniform size of the toner particles, it is possible to make a charge amount of each toner particle uniform upon friction charging. Thus, more excellent tone and developability can be realized.

Also, the cylindrical toner particle preferably has a value derived by dividing the cylindrical length by the cylindrical diameter, the value being in a range from 1.0 to 2.0.

With the above constitution, it is possible to maintain adhesion suited for satisfactory moving of the cylindrical toner toward the image supporting material between the cylindrical toner particles and a magnetic carrier, and thus more excellent tone and developability can be realized.

Furthermore, the cylindrical toner particles preferably have an average circularity of 0.890 or more and 0.920 or less.

With the above constitution, adhesion between the cylindrical toner particles and a magnetic carrier can be maintained more properly, and thus it becomes possible that the toner moves toward the image supporting material more properly.

Also, another aspect of the present invention pertains to the toner for a developer containing the cylindrical toner particles, wherein the toner has an inclination value, Sυ, of melt viscosity-temperature characteristics measured by a flow tester, the value being 10⁴ Pa·S/° C. or lower.

With the above constitution, since the toner particles are formed using the toner composition whose viscosity scarcely decreases upon melting so that an inclination value Sυ of melt viscosity-temperature characteristics of the toner for a developer becomes a fixed value or less, productivity of the toner particles can be improved by suppressing breakage of a cylindrical fiber during the drawing step in the production of the cylindrical toner particles, and also unevenness of fixing properties at low temperature and anti-offset properties can be decreased by decreasing unevenness in the amount of a wax contained in the individual toner particles produced by cutting the cylindrical fiber into fine pieces during the cutting step. Furthermore, by decreasing the exposure area of the wax in the cut surface of the cylindrical fiber, it is possible to suppress various problems involved in exposure of the wax even when the toner is repeatedly used for forming an image for a long period.

The binder resin as the toner component contained in the toner composition is preferably a thermoplastic resin having two or more weight average molecular weight peaks in the molecular weight distribution so that an inclination value Sυ of melt viscosity-temperature characteristics of the toner for a developer becomes 1×10⁴ Pa·S/° C. or lower.

With the above constitution, since the binder resin having multiple molecular weight peaks in the molecular weight distribution is used as the toner component, it is possible to adjust the inclination value Sυ of melt viscosity-temperature characteristics to a fixed value or less by adjusting the proportion of each peak.

Furthermore, it is preferred that an inclination value Sυ of melt viscosity-temperature characteristics of the toner for a developer is 1×10⁴ Pa·S/° C. or lower and the releasant as the toner component contained in the toner composition is a wax having a melting point of 100° C. or lower.

With the above constitution, the toner particles are formed using the toner composition whose viscosity scarcely decreases upon melting so that an inclination value Sυ of melt viscosity-temperature characteristics of the toner for a developer becomes a fixed value or less. Therefore, even when using the wax having the low melting point, it is possible to prevent an increase in the dispersion diameter of the wax as a result of reaggregation during the drawing step which is dispersed finely in the toner composition during the kneading step in the production of the cylindrical toner particles, thus making it possible to maintain a state where the wax is finely dispersed. Furthermore, fixing properties at low temperature of the toner particles can be improved by using the wax having the low melting point.

Also, still another aspect of the present invention pertains to the toner for a developer comprising toner particles in the form of an elliptical body and an external additive, the toner particles in the form of an elliptical body being formed by subjecting the cylindrical toner particles to a surface processing treatment.

With the above constitution, since the toner particles in the form of an elliptical body are those spherodized by the surface treatment of the cylindrical toner particles, circularity increases and physical adhesion of the toner particles can be decreased, and thus faulty cleaning can be reduced.

In the toner particles in the form of an elliptical body, an average circularity is preferably 0.92 or more and 0.95 or less and the standard deviation of particle size distribution is preferably 1.00 μm or less.

With the above constitution, since physical adhesion of the toner particles can be decreased and also charge uniformity of the toner upon friction charging can be improved, it becomes possible to control at a lower applied voltage upon transferring and to decrease the proportion of the overcharged toner.

Also, the toner particle in the form of an elliptical body preferably has a value derived by dividing the major diameter by the minor diameter, the value being in a range from 1.0 to 2.0.

With the above constitution, since the surface area of the toner particles does not increase excessively, physical adhesion of the toner can be decreased.

Furthermore, the toner for a developer, including the toner particles in the form of an elliptical body and an external additive, is preferably used in an image forming apparatus in which a brush cleaning method is used as a method for cleaning a surface of an image supporting material.

With the above constitution, faulty cleaning can be reduced in the image forming apparatus which applies the brush cleaning method of removing a toner from the surface of an intermediate transfer belt using a fur brush.

Still another aspect of the present invention pertains to the toner for a developer comprising the above cylindrical toner particles, and the external additive containing silica having a primary particle size of 10 to 25 nm and a charge amount of 400 to 600 μC/g.

With the above constitution, it is possible to maintain a function of improving fluidity of the toner by silica for a long period by suppressing embedding of silica into the toner particles when a friction force is applied by a regulating blade, thus enabling to improve fluidity of a non-magnetic one-component toner. Also, since the amount of the non-magnetic one-component toner, which is allowed to fly from the thin layers to the image supporting material upon development, can be increased by improving chargeability of the non-magnetic one-component toner, it is possible to improve image density of the formed image and to suppress the occurrence of fog. Furthermore, it is possible to prevent silica fallen from the surface of the toner particles from electrically fixing onto the surface of the image supporting material and thus, the occurrence of dashmark defects on the formed image can be suppressed.

Also, in the cylindrical toner particles which coexist with the silica, the ratio of a length (a) in an axis direction of a cylinder to a length (b) in a diameter direction, a/b, is preferably 2 or less.

With the above constitution, since adhesion between the toner particles and the developer supporting material is properly maintained, the amount of the non-magnetic one-component toner, which is allowed to fly from the thin layers to the image supporting material upon development, can be increased. Therefore, reduction in image density of the formed image, unevenness of the density and fog at the margin portion may not occur when the image is continuously formed. Also, dashmark may not be caused by adhesion maintained properly.

Furthermore, in the two-component developer obtained by mixing the toner for a developer containing the cylindrical toner particles and the external additive with a magnetic carrier, the external additive preferably contains silica having a primary particle size of 10 to 25 nm and a charge amount of 300 to 600 μC/g.

With the above constitution, it is possible to maintain the function of improving fluidity of the toner by silica for a long period by suppressing embedding of silica into the toner particles when a friction force is applied by a regulating blade, and thus fluidity of a toner for a two-component developer can be improved. In a hybrid developing method, it is possible to increase the amount of the toner for a two-component developer, which is allowed to fly from thin toner layers to the image supporting material, by improving chargeability of the toner for a two-component developer. In a two-component developing method, it is possible to prevent a decrease in the amount of the toner for a two-component developer, which is allowed to migrate from magnetic brush to the image supporting material, by improving chargeability of the toner for a two-component developer. Thus it is possible to improve image density of the formed image and to suppress the occurrence of fog and toner scattering.

Also, in the cylindrical toner particles which coexist with the silica, the ratio of a length (a) in an axis direction of a cylinder to a length (b) in a diameter direction, a/b, is preferably 2 or less.

With the above constitution, since adhesion between the toner particles and the surface of the carrier or the surface of the developer supporting material is properly maintained, reduction in image density of the formed image, unevenness of the density and fog at the margin portion may not occur when the image is continuously formed both in the hybrid developing method and in the two-component developing method.

Still another aspect of the present invention pertains to the toner for a developer, which is used in an image forming apparatus equipped with an intermediate transfer belt having a thickness of 300 μm or less.

With the above constitution, by using the cylindrical toner particles, it is possible to decrease adhesion with the surface of the intermediate transfer belt. Therefore, the developer is likely to be separated from the intermediate transfer belt upon secondary transfer, and thus the developer can be satisfactorily moved toward the transfer material. Consequently, even when the intermediate transfer belt has the small thickness, it is possible to suppress the occurrence of a void phenomenon and to suppress the occurrence of distortion and color shift onto a transfer image.

Furthermore, it is preferred that the intermediate transfer belt has a multi-layered structure including an elastic layer and the elastic layer has a thickness of 200 μm or less.

With the above constitution, by using the toner for a developer including the cylindrical toner particles, even if the elastic layer of the intermediate transfer belt has the small thickness, the occurrence of a void phenomenon can be suppressed and the occurrence of distortion and color shift onto a transfer image can be suppressed.

This application is based on patent application Nos. 2006-324343, 2006-324344, 2006-334628, 2006-334629, 2006-350231, 2006-350232 and 2007-143756 filed in Japan, the contents of which are hereby incorporated by references.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds are therefore intended to embraced by the claims.

What is claimed is:

1. A toner for a developer comprising cylindrical toner particles formed of a toner composition containing at least a binder resin and a releasant as toner components, and an external additive, wherein
the cylindrical toner particles have an average circularity of 0.880 or more and 0.930 or less.

2. The toner for a developer according to claim 1, wherein the cylindrical toner particles are formed by transforming the toner composition into a molten state, drawing the molten toner composition into a cylindrical fiber and cutting the cylindrical fiber.

3. The toner for a developer according to claim 1, wherein the cylindrical toner particles have a standard deviation of particle size distribution of 1.20 μm or less.

4. The toner for a developer according to claim 1, wherein the cylindrical toner particle has a value derived by dividing a cylindrical length by a cylindrical diameter, the value being in a range from 1.0 to 2.0.

5. The toner for a developer according to claim 1, wherein the cylindrical toner particles have an average circularity of 0.890 or more and 0.920 or less.

6. The toner for a developer according to claim 1, wherein the toner for a developer has an inclination value, Sυ, of melt viscosity-temperature characteristics measured by a flow tester, the value being 1×10⁴ Pa·S/° C. or lower.

7. The toner for a developer according to claim 6, wherein the binder resin is a thermoplastic resin having two or more weight average molecular weight peaks in a molecular weight distribution thereof.

8. The toner for a developer according to claim 6, wherein the releasant is a wax having a melting point of 100° C. or lower.

9. The toner for a developer comprising toner particles in the form of an elliptical body formed by subjecting the cylindrical toner particles according to claim 1 to a surface processing treatment, and an external additive.

10. The toner for a developer according to claim 9, wherein the toner particles in the form of an elliptical body have an average circularity of 0.92 or more and 0.95 or less and also have a standard deviation of particle size distribution of 1.00 μm or less.

11. The toner for a developer according to claim 9, wherein the toner particle in the form of an elliptical body has a value derived by dividing a major diameter thereof by a minor diameter thereof, the value being in a range from 1.0 to 2.0.

12. The toner for a developer according to claim 9 for use in an image forming apparatus, wherein the apparatus includes an image supporting material and applies a brush cleaning method as a method of cleaning a surface of the image supporting material.

13. The toner for a developer according to claim 1, wherein the external additive contains silica having a primary particle size of 10 to 25 nm and a charge amount of 400 to 600 μC/g.

14. The toner for a developer according to claim 13, wherein the cylindrical toner particle has a ratio of a length (a) in an axis direction of a cylinder to a length (b) in a diameter direction, a/b, of 2 or less.

15. The toner for a developer according to claim 1, which is mixed with a magnetic carrier to give a two-component developer.

16. The toner for a developer according to claim 15, wherein the external additive contains silica having a primary particle size of 10 to 25 nm and a charge amount of 300 to 600 μC/g.

17. The toner for a developer according to claim 15, wherein the cylindrical toner particle has a ratio of a length (a) in an axis direction of a cylinder to a length (b) in a diameter direction, a/b, of 2 or less.

18. The toner for a developer according to claim 1 for use in an image forming apparatus, wherein the apparatus is equipped with an intermediate transfer belt having a thickness of 300 μm or less.

19. The toner for a developer according to claim 18, wherein the intermediate transfer belt has a multi-layered structure including an elastic layer and the elastic layer has a thickness of 200 μm or less.
